(19) United States
(12) Patent Application Publication
(10) Pub. No.: US 2025/0022337 A1
(43) Pub. Date: Jan. 16, 2025

(54) PLACEHOLDER FEATURE ELECTRONIC PULL-TAB SYSTEM AND METHOD

(71) Applicant: Pilot Gaming Systems, Inc., Reno, NV (US)

(72) Inventors: Jon Weaver, Birmingham, MI (US); Anthony M. Morelli, Mt. Pleasant, SC (US)

(21) Appl. No.: 18/764,915

(22) Filed: Jul. 5, 2024

Related U.S. Application Data
(60) Provisional application No. 63/525,646, filed on Jul. 7, 2023.

(51) Int. Cl. G07F 17/32

(52) U.S. Cl. CPC G07F 17/3213; G07F 17/329

(57) ABSTRACT

A pull-tab gaming system and method are described having non-paying placeholder symbols displayed. The gaming system includes a network component and a gaming device. The network component generates an electronic pull-tab deck including a plurality of electronic pull-tab tickets. Each of the tickets is associated with a ticket value, a display area, and a symbol identification and location for each of a plurality of final game symbols. In operation, a gaming device generates a ticket request and communicates the request to the network component. The network component selects one ticket associated with the location for one or more placeholder symbols and transmits that ticket. The gaming device receives the electronic pull-tab ticket from the network component and displays the display area corresponding to the ticket. An input received at the gaming device causes the display an animation corresponding to the award value, the display area, the symbol identification and location for each of the plurality of final game symbols, and the location for each of the one or more placeholder symbols.

### CROSS-REFERENCES

This patent application claims the benefit of provisional patent application 63/525,646 entitled PLACEHOLDER FEATURE ELECTRONIC PULL-TAB SYSTEM AND METHOD, filed on Jul. 7, 2023; and

the above patent application is hereby incorporated by reference in this patent application.

### FIELD

A system and method for providing placeholder feature electronic pull-tab game sessions are described. More particularly, the placeholder feature electronic pull-tabs include placeholder symbols covering one or more game symbol display positions that reveal final game symbols through an animation.

### BACKGROUND

Typical wagering devices include slot machines and video lottery terminals and are normally managed by various types of computer systems which monitor and control their activities. Such wagering devices are typically located in casinos, racetracks, tribal gaming locations, fraternal organizations, lottery outlets or other authorized locations. These are generally capital-intensive operations requiring a significant capital expenditure.

Wagering system have been developed where a central computer system is interconnected via one or more of a variety communication mechanisms to a multiplicity of venues where wagering devices, such as VLTs or slot machines, allow players to play via the insertion of cash or equivalent into the machines. The information associated with the wagering devices is transmitted to the central computer, which provides security monitoring and accounting services. Many varieties of such systems exist.

The wagering devices may operate as stand-alone wagering devices, in which the wagering activity and prize awards are handled principally by the retail device, e.g., slot machine, and the central system is tasked with monitoring and reporting activities associated with the retail device. Other stand-alone wagering devices are more highly integrated with the central system, in which the central system performs some or all of the game play and the retail device reflects the wagering results determined by the central system.

Typically, the traditional wagering devices in the retail venues are proprietary devices that incorporate coin and or currency accepting devices. In some instances, the wagering devices may include credit or debit card readers, although that is prohibited by law and/or regulation in many jurisdictions.

More recently, central systems have been developed that use commercial digital tablets or similar mobile devices that are configured and operated at a particular venue. These mobile devices do not have coin or currency readers. Instead the mobile devices operate in conjunction with a cashier operated point-of-sale (POS) device, or a kiosk. In operation, a cashier will accept funds from a person that desires to use an application on the tablet and the cashier uses functions on the POS device to fund a temporary account that is tied to a particular venue's mobile device; the mobile device is then loaned to the user. In some jurisdictions systems exist that allow personal mobile devices, e.g., smartphones, to be used as a wagering device that operates wagering games in various online configurations.

While these centralized systems provide players greater flexibility as to when and how they play traditional casino and charity games, the fundamental game mechanics the players experience have not changed.

Because there is continuing competition for players' attention from different game animations, volatility, location flexibility, there is a continuing need to provide new interesting gaming opportunities, such as new and interesting gaming mechanics.

### SUMMARY

A pull-tab gaming system and method are described having non-paying placeholder symbols displayed. The pull-tab gaming system includes a network component communicatively coupled to a gaming device that includes a processor, a memory, and a display. The network component generates an electronic pull-tab deck that includes electronic pull-tab tickets. Each of the electronic pull-tab tickets is associated with a ticket value, a display area, and a symbol identification and location for each of a plurality of final game symbols. The display area includes a plurality of game symbol display positions.

In operation, the gaming device generates an electronic pull-tab ticket request and communicates that request to the network component. The network component then selects one electronic pull-tab ticket associated with the location for one or more placeholder symbols. The gaming device receives the electronic pull-tab ticket from the network component and displays the display area corresponding to the electronic pull-tab ticket.

An input is received at the gaming device that causes the gaming device to present an animation corresponding to the award value, the display area, the symbol identification and location for each of the plurality of final game symbols, and the location for each of the one or more placeholder symbols. The animation displays the one or more placeholder symbols covering one or more final game symbols and displays removal of the one or more placeholder symbols to reveal the one or more final game symbols covered by the one or more placeholder symbols.

The pull-tab gaming method commences when a network component generates an electronic pull-tab deck that includes a plurality of electronic pull-tab tickets. Each of the tickets includes an award value, a display area, and a symbol identification and location for each of a plurality of final game symbols. At least one of the electronic pull-tab tickets is associated with a location for each of one or more placeholder symbols. A plurality of game symbol display positions is associated with the display area. The gaming device is communicatively coupled to the network component and includes a processor, a memory, and a display. The gaming device generates an electronic pull-tab ticket request and communicates the request to the network component. In response, the network component selects one electronic pull-tab ticket associated with the location for one or more placeholder symbols. When the gaming device receives the selected electronic pull-tab ticket having the location for one or more placeholder symbols, the gaming device displays the display area corresponding to that electronic pull-tab ticket. The gaming device receives an input that causes the gaming device to present an animation corresponding to the award value, the display area, the symbol identification and location for each of the plurality of final game symbols, and the location for each of the one or more placeholder symbols. This animation displays the one or more placeholder symbols covering one or more final game symbols in the display area and shows the removal of the one or more placeholder symbols to reveal the one or more final game symbols covered by the one or more placeholder symbols in the display area.

### BRIEF DESCRIPTION OF THE DRAWINGS

The present invention will be more fully understood by reference to the following drawings which are presented for illustrative, not limiting, purposes.

FIG. 1 shows an illustrative centralized gaming system.

FIG. 2 shows an illustrative authorized mobile device or point-of-sale device.

FIG. 3 shows detail of the mobile wagering sub-system.

FIG. 4 shows an illustrative point-of-sale (POS) device communicatively coupled to authorized mobile devices in a gaming venue.

FIG. 5 shows an illustrative Video Presentation System.

FIG. 6 shows a more detailed view of an illustrative video presentation sub-system (VPS) client.

FIGS. 7A and 7B show a placeholder feature electronic pull-tab ticket gaming method that describes the various steps performed by a player interacting with the gaming system.

FIGS. 8A-H show illustrative game screens for various stages of gameplay for single symbol placeholder electronic pull-tab tickets.

FIGS. 9A-G show illustrative game screens for various stages of gameplay for grid placeholder electronic pull-tab tickets with a Replay animation.

FIGS. 10A-D show illustrative game screens for various stages of gameplay for row placeholder electronic pull-tab tickets with a Replay animation.

FIGS. 11A and 11B show an illustrative flowchart for a method of providing single symbol placeholder electronic pull-tab tickets.

FIGS. 12A and 12B show an illustrative flowchart for a method of providing row and grid placeholder electronic pull-tab tickets with a Replay animation.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. The various illustrative embodiments will now be described more fully with reference to the accompanying drawings. It should be understood that this disclosure and the claims may be embodied in many different forms and should not be construed as limited to the embodiments set forth herein. Additionally, those familiar with computing systems shall appreciate that there are many variants possible for the described systems, depending on the nature of the available networks, legal frameworks, which can open or restrict the types of locations in which the system can be operated, advances in server and networking technologies, etc.

The gaming systems and methods presented herein include a mobile wagering and entertainment system that is designed to be used in wagering applications within legal gaming frameworks. More specifically, the gaming systems and methods presented herein support centralized control of placeholder feature electronic pull-tab ticket wagering that takes place in multiple wagering venues and provides an integrated broadcast capability so that an entertaining complement to the wagering can be presented on television screens in the gaming venues.

A gaming venue includes a charity, a casino and any other such authorized or licensed gaming venue. Additionally, a gaming venue includes a church, hotel, bar, restaurant, convenience store and other such locations that support licensed gaming activity. Note, that the term “gaming” refers to games of chance or games that include a chance component, in which a wager is received and the awarded prize is dependent on the outcome of the game of chance or of the chance component.

As described in further detail herein, the gaming system and method includes a Mobile Wagering Sub-system (MWS), a Video Presentation Sub-system (VPS), and placeholder feature electronic pull-tab tickets. The gaming system is communicatively coupled to a plurality of remote gaming venues, in which each remote gaming venue has at least one mobile client device that supports customer wagering. Additionally, each remote gaming venue may include one or more Point-of-Sale stations that manage player funds. Furthermore, each remote gaming venue may include one or more television monitors that broadcast content complementary to wagering activities. In the illustrative embodiments presented herein, the various elements of the gaming system are communicatively and operatively coupled to one another with a network structure that includes the Internet as the backbone and at least one secure Wi-Fi network within each gaming venue.

The centralized gaming system provides placeholder feature electronic game sessions that include one or more placeholder symbols that delay the reveal of the final game symbols during a game session.

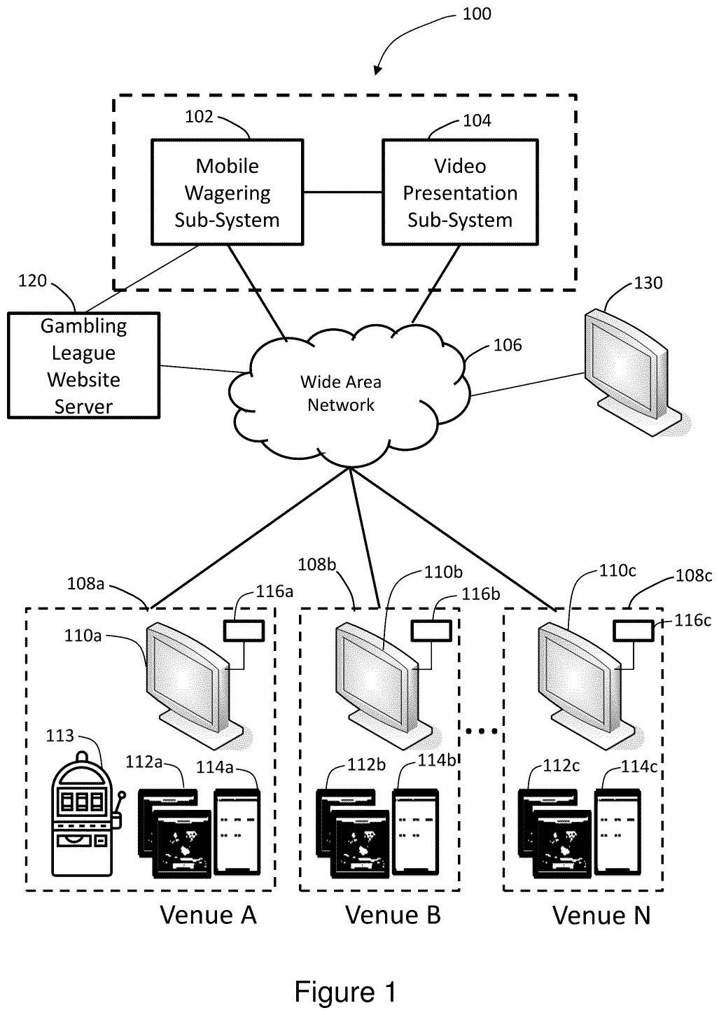

Referring to FIG. 1, there is shown an illustrative centralized gaming system. The centralized gaming system 100 includes a mobile wagering sub-system 102 and a video presentation sub-system 104. The mobile wagering sub-system 102 and the video presentation sub-system 104 are communicatively coupled to one another. Additionally, the mobile wagering sub-system 102 and the video presentation sub-system 104 are communicatively coupled to a Wide Area Network 106, e.g. Internet, which is communicatively coupled to a plurality of gaming venues, namely, gaming illustrative Venue A 108a, Venue B 108b and other such gaming venues as represented by Venue N 108c. Each of the plurality of gaming venues 108a, 108b and 108c include a stationary monitor 110a, 110b and 110c, respectively. Each stationary monitor 110a, 110b and 110c is communicatively coupled to the video presentation client 116a, 116b and 116c, respectively. The video presentation clients 116 are also communicatively coupled to the video presentation subsystem 104. The combination of the stationary monitor 110 and the video presentation client 116 may also be referred as a “stationary monitor client,” and as such reference to “stationary monitor client” refers to the combination of the stationary monitor 110 and the video presentation client 116.

Within the system architecture each gaming venue may be associated with a sponsoring organization, e.g. a charity, and an additional business entity, e.g. a distributor. The types of venues, sponsoring organizations and other business entities will vary according jurisdictional statures and regulation.

Additionally, each of the gaming venues 108a, 108b and 108c include a plurality of authorized mobile devices 112a, 112b and 112c, respectively. Further still, each of the gaming venues includes a Point-of-Sale (POS) device 114a, 114b and 114c. The illustrative authorized mobile devices 112 and the POS devices 114 are client devices configured to communicate with each other and the mobile wagering subsystem 102. In operation, the authorized mobile devices 112 and POS devices 114 are registered with the mobile wagering sub-system 102, which includes a database (not shown) that associates the authorized mobile devices 112 and POS devices 114 with a designated gaming venue 108. Thus, authorized mobile devices 112 and POS devices 114 are not allowed to interact with the centralized gamine system 100 when the client devices are not located at the designated gaming venue.

The illustrative authorized mobile devices 112 operate as wireless client devices that are communicatively coupled to the centralized gaming system 100. Additionally, the centralized gaming system 100 may be communicatively coupled to authorized non-mobile clients. Furthermore, other client devices such as non-mobile clients may be disposed in the gaming venues and these non-mobile clients may be communicatively coupled to the centralized gaming system 100. These authorized non-mobile client devices include, but are not limited to, wired devices such as gaming machines, slot machines, PCs, stationary monitors, Internet appliances, Internet of Things (Iot) devices and other such non-mobile devices with hardwire connections or wireless connections to the Wide Area Network 106. The non-mobile client devices may be configured to participate in the games presented herein including, but not limited to, the tournament games described hereinafter.

Operationally, client devices must comply with the system-centric gaming requirements in which all gaming and accounting activity are controlled by the mobile wagering sub-system 102 servers, and have the communications infrastructure, directly or by proxy, to interact with the server in a manner consistent with the operations of the authorized mobile devices 112 described herein.

The illustrative gaming system 100 includes a plurality of server applications that are configured to provide high-availability and redundancy, process all inputs and generates outputs. The illustrative gaming system 100 includes three different types of network communications. Firstly, there are network communications between the internal server components, namely, the mobile wagering sub-system 102 and the video presentation sub-system 104. Secondly, there are network communications between the server components, e.g. the mobile wagering sub-system 102 and the video presentation sub-system 104, and the remote gaming venues 108a, 108b and 108c, as well as the Gambling League Website server 120. Thirdly, there are network communications within the gaming venues 108a, 108b, and 108c.

With respect to network communications between the internal server components, the illustrative server components operate as a single network, in which the servers can communicate with one another using service requests. By way of example and not of limitation, the illustrative internal server components have two internet protocol addresses, namely, a Private IP used to maintain the server network and ensuring secure server-to-server communication, and a Public IP that is bound to the Internet and that provides access to server services through high security communications such as HTTPS. The internal server components use their private IPs for server-to-server communication so that these services are not exposed to the Internet, the game application running on the authorized mobile devices and the POS devices.

By way of example and not of limitation, each server is configured with an SSL certificate which supports HTTPS calls. The illustrative server is configured to forward some requests it receives through HTTPS to a local port, and the requests that are allowed to pass are only those available to authorized “Game” and “POS” devices. This illustrative configuration ensures that only very specific requests are allowed from the public IP.

By way of example and not of limitation the servers are implemented using the Linux operating system using Restful programming techniques using Java as the programming language with Jersey RS support. Database structures are contained in a MySQL database.

Communication between the server components, namely, the mobile wagering sub-system 102 and the video presentation sub-system 104, and the remote client devices is performed over a wide-area network 106. As described above, these network communications are performed using secure SSL communications over the Internet.

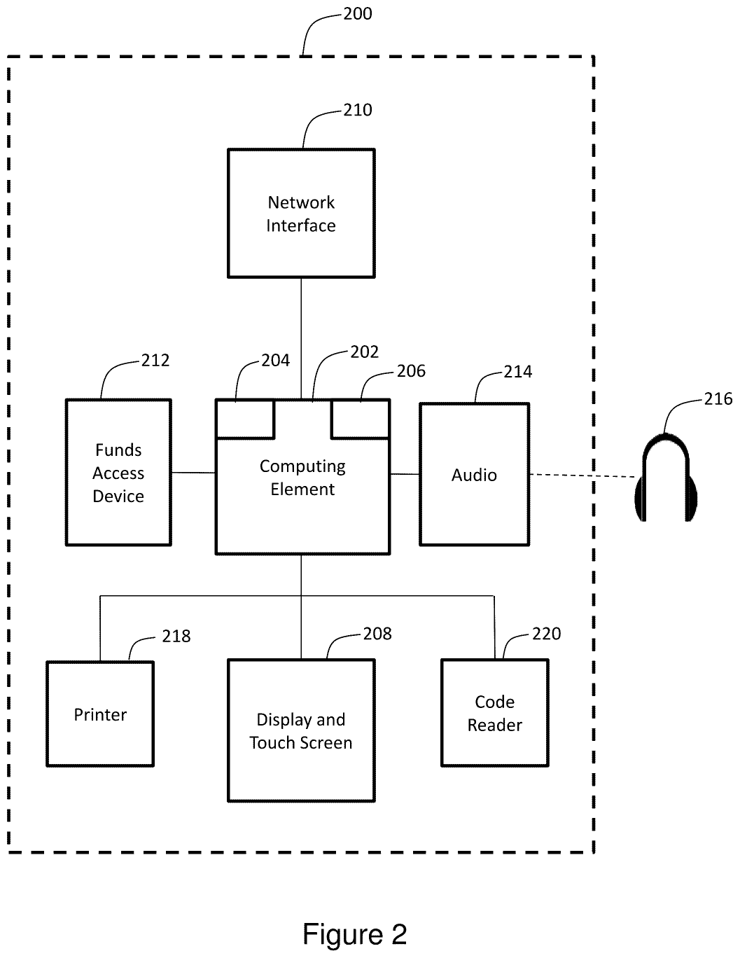

The authorized mobile devices 112a, 112b and 112c are also referred to as a “player interface unit.” An illustrative authorized mobile device is presented in FIG. 2. Operationally, each authorized mobile device 112 in an illustrative embodiment is associated with a player account.

By way of example and not of limitation, the player account is described as a short-term, anonymous entity tied to the client device being used by the player, and which expires when the fund balance drops to zero. However, it is possible in other embodiments to have player accounts which may exist for longer time periods and be tied to a player.

Additionally, it should be noted that while the illustrative embodiments presented herein generally describe financial transactions such as adding funds or cashing out at the POS device 114, in different regulatory environments or with different technology, such player accounts can have financial transactions originating at the player device or any other client device that may be configured to support POS transaction. Also, the financial transactions may be supported at a system level with a server component or server module that provides a web portal functions for financial transactions. Thus, the financial transactions may be performed by the client device, a server component, a server module, or any combination thereof. Depending on regulatory issues and available technology, financial transactions may be based on cash, credit cards, debit cards, digital currency or other mediums of finance.

Referring now to FIG. 2, there is shown an illustrative player interface unit 200. The player interface unit 200 can comprise the authorized mobile device 112, the point-of-sale device 114, and any combination thereof. For example, the illustrative player interface unit 200 may be one of the plurality of authorized mobile devices 112 that are associated with each venue. The illustrative player interface unit 200 includes a central computing element 202 with a processor 204 and memory storage 206. One or more games may be pre-installed on the player interface unit 200 before the player interface units are deployed in a gaming venue or other such production environment. Alternatively, the illustrate game title files may be stored in a remote server, e.g. an “App” store, and the player interface unit 200 may be configured to download the game title file, run the game title file and enable the user to interact with the corresponding game title.

The player interface unit 200 also includes a color display with a touch-screen 208 and a network interface component 210, which provides network access to a local area network, a wide area network or any combination thereof. By way of example and not of limitation the network interface component supports a wireless local area network such as a Wi-Fi network, which is based on IEEE 802.11 standards. Additionally, the player interface unit 200 may communicate with the wide area network 106 via the illustrative Wi-Fi network. The communication between the player interface unit 200 and the mobile wagering sub-system 102 may be performed using the illustrative HTTPS protocol or other such secure networking protocol that allows game session inputs, commands and outputs to be communicated securely across the Wide Area Network.

In an illustrative embodiment, the player interface unit 200 may be a tablet computing device running iOS or Android operating systems. The illustrative player interface unit may also include a Funds Access Device module 212 that may be configured to have a custom locked profile to evade security-bypassing attempts. The Funds Access Devices (FAD) 212 may also provide alternative methods for starting play sessions or adding funds to existing sessions. By way of example and not of limitation, the Funds Access Device module 212 may include currency readers and debit/credit card readers such as a magnetic stripe reader, a smart-card reader, an infra-red reader, a Near-Field-Communications reader and other such financial transaction readers.

The player interface unit 200 may also include an audio system component 214 that enhances the game-playing experience for the players. The audio system component 214 may also include a standard audio jack so that a player can use wired or wireless headphones 216 to improve the game audio environment without disturbing others.

In one illustrative embodiment, the player interface unit 200 may include a printer 218 and a code reader 220. By way of example and not of limitation, the printer 218 generates vouchers. The illustrative code reader 220 may be embodied as a bar-code reader that is configured to read vouchers generated by the printer.

By way of example and not of limitation, the player interface unit 200 may be configured to include a “HELP” button in the game client that also dispatches a signal to the POS to notify the operator that the player is requesting assistance. The player interface unit 200 may also be configured to include a text-to-speech functionality to aid a visually impaired player. Additionally, the player interface unit 200 may include a gaming application that downloads files, decompresses the downloaded files if they have been compressed, and caches all assets inside the player interface unit 200. The player interface unit 200 supports dynamic updates without the need to update the game client itself.

Referring now to FIG. 1 and FIG. 2, the mobile wagering sub-system 102 is communicatively coupled to a plurality of authorized mobile devices 112 such as illustrative player interface unit 200 presented in FIG. 2. In one illustrative embodiment, the mobile wagering sub-system 102 receives a wager input for a game session from the illustrative player interface unit 200. In another illustrative embodiment, the mobile wagering sub-system 102 receives the wager input for a game session from a plurality of authorized mobile devices 112, which may disposed at one or more venues as presented in FIG. 1.

The illustrative player interface unit 200 presents a user interface on touch screen 208 that shows a plurality of game content associated with different types of game sessions. In the illustrative embodiment, the player interface unit 200 may also accept player inputs that are associated with a game session. The game session may perform various operations as described in further detail below.

In the illustrative embodiment, the video presentation sub-system 104 is communicatively coupled to the mobile wagering sub-system 102, the video presentation client 116, and the stationary monitors 110 disposed in the different gaming revenues. The video presentation sub-system 104 generates entertainment output associated with ongoing activity in the mobile gaming system.

One or more of the stationary monitors 110 then receives the entertainment output generated by the video presentation sub-system. The stationary monitors 110a, 110b and 110c then proceed to display the entertainment output generated by the video presentation sub-system 104.

In the illustrative embodiment, a first plurality of authorized devices 112a associated with a first gaming venue 108a includes a first stationary monitor 110a and first video presentation client 116a. Additionally, a second plurality of authorized mobile devices 112b associated with a second gaming venue 108b includes a second stationary monitor 110b and second video presentation client 116b. The first stationary monitor 110a and the second stationary monitor 110 are both communicatively coupled to video presentation sub-system 104. The video presentation sub-system 104 may have stored thereon an entertainment output, such as a video, that is associated with wagering activity. The video presentation sub-system 104 communicates the output, e.g. video, to the first stationary monitor 110a and the second stationary monitor 110b via the video presentation client 116a and 116b, respectively.

By way of example and not of limitation, for an illustrative bingo tournament game that includes a bingo game session, the various stationary monitors 110a, 110b and 110c may present a bingo video related to the bingo tournament game. Thus, a plurality of different authorized mobile devices 112 from different gaming venues 108 can participate in the bingo tournament game and share a similar video experience.

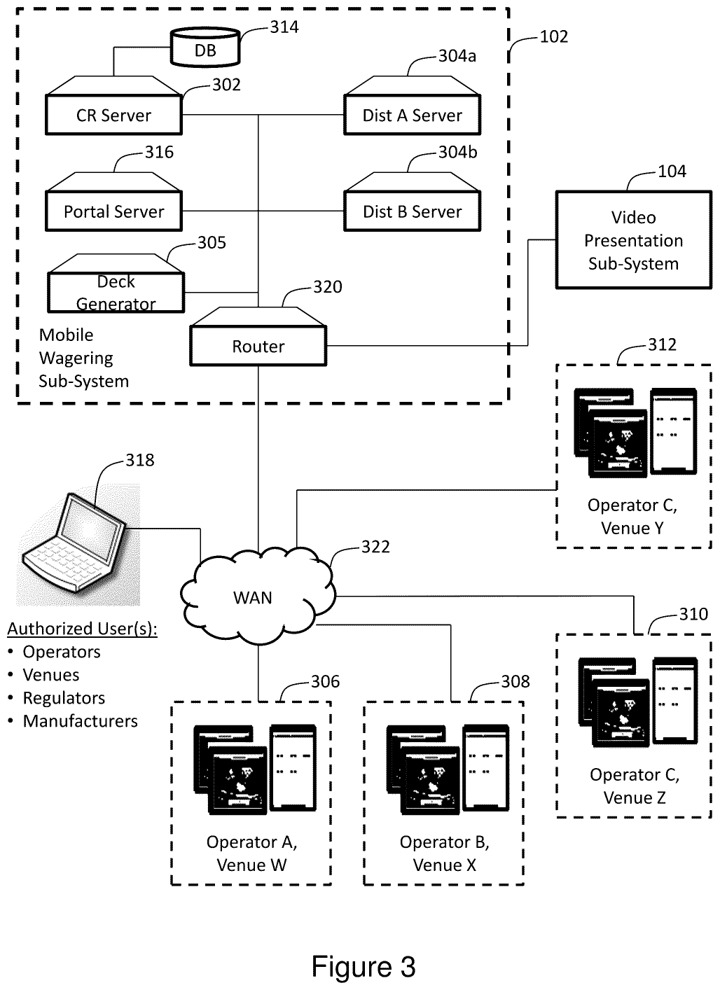

Referring to FIG. 3, there is shown further detail for the mobile wagering sub-system 102 communicatively coupled to different venues. In an illustrative embodiment, the mobile wagering system functionality is distributed on multiple servers, including those that provide database 314 functionality. The illustrative mobile wagering sub-system 102 includes a centralized resource server 302 or centralized manufacturer server that performs as a coordinating entity for system operation and maintains authority over game operations controlled by the centralized gaming system 100. The mobile wagering sub-system 102 also includes a distributor server 304 that is communicatively coupled to the centralized resource server 302.

In the illustrative embodiment presented in FIG. 3, a first distributor server 304a and second distributor server 304b are also communicatively to the centralized resource server 302. Each of the illustrative distributor servers is configured to manage and control the game operations and cashier operations performed at a set of gaming venues that are associated with a distributor who is responsible for sales and support of a multiplicity of venues.

For example, a first set of gaming venues 306 and 308 are configured to communicate with first distributor server 304a, which manages and controls the game operations at gaming venues 306 and 308. Additionally, for a second set of gaming venues 310 and 312 are configured to communicate with the illustrative second distributor server 304b manages and controls the game operations at gaming venues 310 and 312. Thus, multiple gaming venues may require additional distributor servers.

A variety of tasks may be performed by the centralized resource server 302. For example, one of the tasks performed by the centralized resource server 302 includes providing a central routing operation for each of the authorized mobile devices 112 so that each authorized mobile device 112 is routed to the proper distributor server 304a or 304b upon activation of each authorized mobile device. By way of example and not of limitation, the first request generated by a player interface unit 200 may direct the player interface unit 200 to an illustrative distributor of the player interface unit 200.

Additionally, the centralized resource server 302 may be configured to provide a central routing operation for cashier authentication. Thus, a cashier device may be authenticated by the appropriate distributor server 304, which may then forward an authentication to an illustrative mobile device distributor.

The centralized resource server 302 may also be configured to operate as a central authority for generation of finite decks of predetermined electronic pull-tab results, including placeholder feature electronic pull-tab decks and their associated results. In some embodiments, the mobile wagering sub-system 102 further includes a separate deck generator server 305 that operates as the central authority for generation of finite pool decks of predetermined electronic pull-tab results, including the placeholder feature electronic pull-tab decks and their associated results. In these embodiments, the deck generator server 305 is communicatively coupled to one or more of the distributor servers 304a and 304b, as well as to the centralized resource server 302, and the deck generator server 305 both randomizes the decks of electronic pull-tabs and distributes the randomized tickets from the decks.

In another illustrative embodiment, a separate system (not shown) may be responsible for generation of one or more finite decks, in which a distributor server (not shown) or centralized resource server (not shown) may communicate with a deck generator server (not shown) to randomize finite pool decks.

Furthermore, the centralized resource server 302 may be configured to manage and control financial information. The centralized resource server 302 may include a centralized database 314 that stores data generated by the cashiers, authorized mobile devices, and the various gaming venues. The centralized database 314 provides a central repository for accounting data, game play data, system configuration data, and other such data types.

The illustrative distributor servers 304 are communicatively coupled to the centralized resource server 302. Each of the distributor servers 304 may be configured to manage finances for the player accounts that are associated with the authorized mobile devices. Additionally, the illustrative distributor servers 304 may be responsible for generating logs and reports required for the POS devices. Furthermore, the illustrative distributor servers 304 may be configured to manage game play operations, wagers and prizes. Further still, the illustrative distributor servers 304 may manage cashier operations including customer sales and redemptions. Further yet, the distributor servers 304 may be configured to maintain the financial status for the authorized mobile devices, including the actual credit balance on each player device.

In an alternative embodiment, the operations performed by the centralized resource server 302 and the distributor server 304 may be performed by a centralized resource software module (not shown) and a distributor software module (not shown) that may be associated with a client-server architecture, a distributed architecture, a peer-to-peer architecture, a hierarchical architecture, a “cloud” architecture or any combination thereof.

The mobile wagering sub-system 102 may also include an illustrative web portal server 316. The web portal server 316 provides a web interface to access system accounting and operational data, as well as to maintain and configure the system. The web portal server 316 is configured to support creating, editing and removing entities like distributors, operators, venues, cashiers, devices, game parameters and others as required. All actions performed on the portal are logged for auditing purposes. This action log can be access on the portal itself if the user has the necessary system privilege.

Additionally, the pull-tab gaming system and method described may be embodied in a fixed slot machine style cabinet communicatively coupled to one or more servers, such as a Casino Management System (CMS), which is well known in the art. The illustrative CMS server would operate as a network component.

By way of example and not of limitation, the web portal server may be accessed from personal computers or tablet devices 318 over the internet. Authorized users having “administrator” privileges may access system reports and controls based upon their operational needs and organizational affiliation. The web portal server 316 supports a variety of different authorized users having different roles with different levels of access to the mobile wagering sub-system 102. For example, the web portal server may be configured to support the following roles: regulator, manufacturer, distributor with access to multiple operators, operator with access to multiple venues, a particular venue, a particular cashier and other such preconfigured roles.

An illustrative router 320 is disposed within the mobile wagering sub-system 102. The router 320 is communicatively coupled to a wide area network 322, e.g. Internet, which is communicatively coupled to the various venues and authorized users. Additionally, the illustrative router 320 is communicatively coupled to the portal server 316, the video presentation sub-system 104, each distributor server 304 and the centralized resource server 302. The router 320 forwards data packets to the appropriate server, network, internet appliance, sub-system and other such destination. Additionally, the router 320 may include a firewall that supports secure communications with the mobile wagering sub-system.

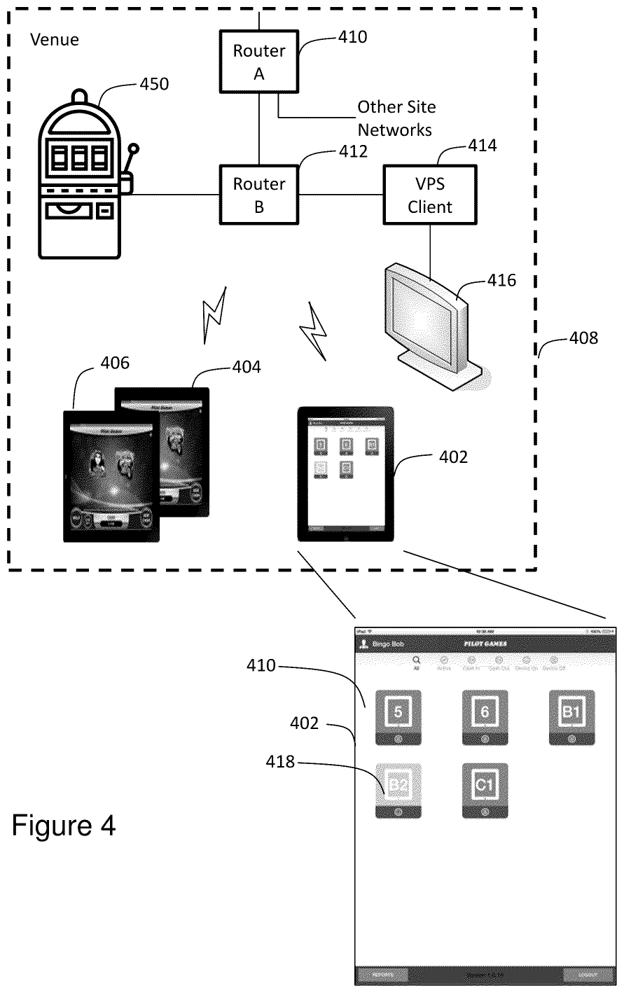

Referring now to FIG. 4, there is shown an illustrative point-of-sale (POS) device communicatively coupled to authorized mobile devices in a gaming venue. The illustrative POS device 402 is communicatively coupled to one or more authorized mobile devices 404 and 406 in gaming venue 408. By way of example and not of limitation, the illustrative POS device 402 is communicatively coupled to authorized mobile devices with a native Socket implementation inside a Local Area Network. An exploded view of an illustrative user interface 410 corresponding to POS device 402 is also shown.

The point-of-sale device 402 is configured to manage all cash operations such as cash-in operations and cash-out operations. The cash-in and cash-out operations may be requested by the authorized mobile device 404, the authorized mobile device 406, the POS 402 or any combination thereof.

The illustrative point-of-sale (POS) device 402 and authorized mobile devices 404 and 406 may be embodied as a mobile device as described above in FIG. 2. The illustrative POS device 402 is a client device configured to receive and operate an illustrative proprietary POS Application. The authorized mobile devices 404 and 406 are client devices configured to receive and operate a proprietary Game Application. The illustrative POS device 402 and authorized mobile devices 404 and 406 are communicatively coupled with the mobile wagering sub-system 102. In the illustrative embodiment, the client devices communicate with the mobile wagering sub-system 102 for each transaction. More generally, all wagering and accounting information is monitored and stored in the centralized gaming system 100 and the client devices always reflect the information received from the centralized gaming system 100. For reasons of security and consistency all game play decisions and financial data is hosted in the centralized gaming system and only visually reflected in the client devices.

As shown in FIG. 4, the illustrative wide area network 106, e.g. Internet, (shown in FIG. 1) is communicatively coupled to the illustrative gaming venue 408. In the illustrative embodiment, the illustrative wide area network terminates at Router A 410. The illustrative Router A 410 may be a pre-existing router located at the venue 408 and usable for multiple purposes, depending on the needs of the venue. For example, Router A 410 may be a component of a cable IV system. In the illustrative embodiment, a second Router B 412 is also communicatively coupled to router A 410. Illustrative Router B 412 is configured to support the requirements for communications with the mobile wagering sub-system 102 and video presentation sub-system 104.

In the illustrative embodiment, router B 412 establishes two private Wi-Fi SSIDs to be used only at a specific site. Each Wi-Fi SSID includes a security key that is unique to that site and is not available to site personnel. One SSID may be used for the exclusive use of the mobile wagering sub-system 102 and a second SSID may be provided for exclusive use of the video presentation system 104. Router B is also communicatively coupled to video presentation client 414, which is communicatively coupled to the monitor 416.

The illustrative POS 402 tablet is an electronic device that may be operated cashier in a venue. The POS device 402 provides control over financial activity within the venue. The illustrative POS Application program runs on a tablet device and supports the following illustrative operations, namely, a cash-in operation (sales), a cash-out operation (redemption) and a reporting operation.

In the illustrative embodiment, the cashier logs into the POS application program by providing a cashier user name and password. During the set-up process, the cashier name is associated with a cashier role that is associated only with a particular venue. After a successful login, the POS client retrieves relevant system information from an illustrative distributor server 304, which presents the user interface 410.

The illustrative user interface 410 associated with POS client 402 presents colored icons, in which each icon represents one of the authorized mobile devices (such as authorized mobile devices 404 and 406) in the venue 408. Note that the illustrative authorized mobile devices 406 and 408 may also be referred to as “a registered gaming client.” By way of example, each icon 418 has a short identifier representing the local identification of the device, which is unique within that venue. For example, a grey icon may identify that the authorized mobile device has been registered with the mobile wagering sub-system; however, the authorized mobile device is not currently available for game play. Another illustrative icon may be a yellow icon, which represents that the authorized mobile device is present and available. A green icon may represent that the authorized mobile device has credit and is involved in a game session. A red icon may represent that a player input has been received that relates to a HELP button input command, a cash input command or a cash output command.

In operation, an illustrative cashier that is interactive with the user interface 410 may select an icon associated with a particular authorized mobile device. After selecting the appropriate authorized mobile device, the cashier may interact with another user interface that enables the cashier to add cash to the authorized mobile device, to enable a player cash-out from the authorized mobile device, to display a log of recent play and transactional activity, which may be retrieved from the illustrative centralized resource server, the distributor server or any combination thereof.

A variety of other user interfaces may also be presented in the point-of-sale device. For example, a user interface may be presented that allows the illustrative cashier to access reports and to log-out from the POS device. For example, a reports screen may be presented that summarizes the business activity of the current day, the previous day or a historical period. The reports may include data regarding cash-in sales (in dollars), awarded prizes (in US Dollars) and net revenue, which is the difference between the cash-in sales and the awarded prizes. The illustrative reports screen may be refreshed in real time or in pseudo real time.

By way of example and not of limitation, a player may interact with the centralized gaming system 100 by purchasing play credits, e.g. funds, at the POS device 402. For example, the illustrative player requests an amount of credit and pays the cashier at POS device 402. Subsequently, a POS session is established with the central database 314 (shown in FIG. 3) when the illustrative distributor server 304 receives a cash-in message from the POS client device 402. The illustrative cash-in message identifies the session amount, the identification of the authorized mobile device to which the POS session amount is linked and the identity of the POS device initiating the transaction. The distributor server 304 acknowledges that POS transaction and provides update information to the specific game client indicating the amount of available at credit. In addition, a player may elect to add credit to an existing balance by purchasing such credit from a cashier, who may use a POS ADD CASH function to record the transaction in the server database and update the available credit total.

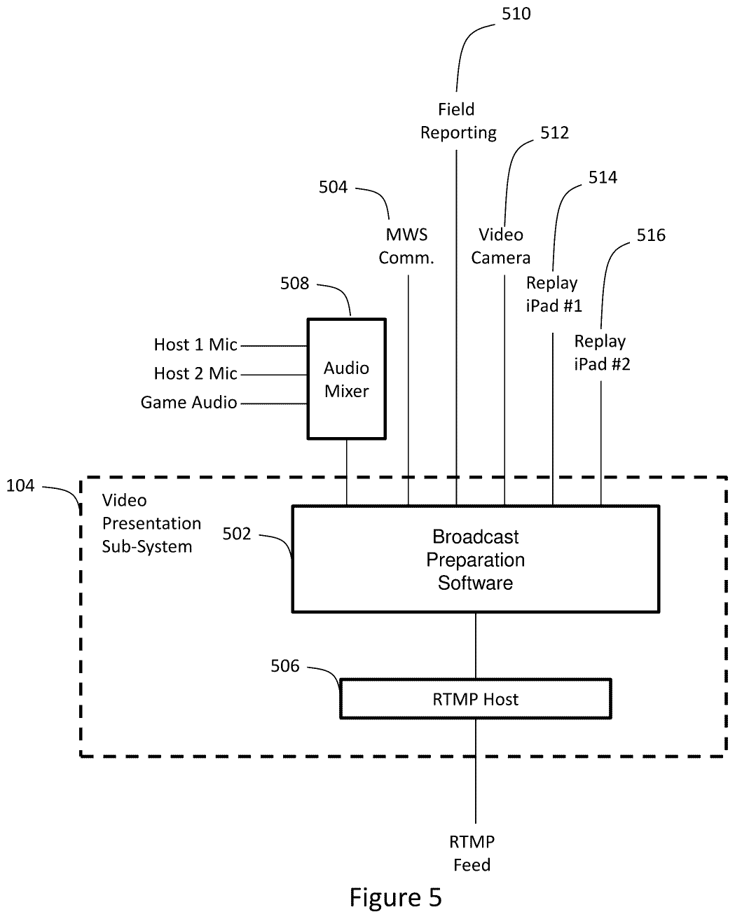

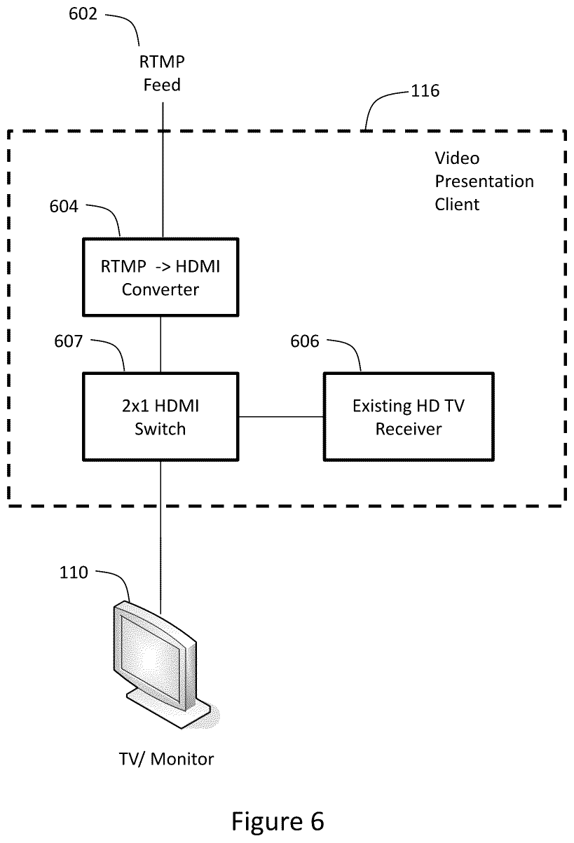

Referring to FIG. 5, there is shown an illustrative Video Presentation System (VPS). In the illustrative embodiment, the video presentation system (VPS) 104 delivers television content to venues communicatively coupled to the centralized gaming system 100 shown in FIG. 1. The illustrative VPS 104 is communicatively coupled to a VPS client 116, which is also shown in FIG. 6 below.

By way of example and not limitation, the VPS 104 may be associated with linked bingo tournament (LBT) games, electronic pull-tab tournaments, and other tournament games more generally. This content presented on illustrative monitors 110 (shown in FIG. 1) complements the game experience on the authorized mobile devices 112. Additionally, the content presented on monitors 110 is configured to involve other patrons at participating venues who are not participating in the games. This may create a social gaming environment that may appeal to a broad spectrum of players.

The illustrative VPS 104, shown in FIG. 5, includes a plurality of inputs that the system may incorporate into broadcast content. For example, communications with the MWS 102 may include a data feed generated by the MWS 102, which provides real time data on the status of an illustrative tournament. The illustrative data feed may include player names, player scores, remaining plays for player game sessions, time remaining in the tournament, prize values and other such tournament information.

A broadcast preparation software module 502 is configured to integrate a plurality of inputs into a broadcast data stream. In the illustrative embodiment, the integration is performed by a suite of commercial products such as Open Broadcaster™, Quicktime™, and proprietary software products. The tasks performed by the broadcast preparation software module 502 includes formatting an illustrative mobile wagering sub-system data feed 504. Note, the mobile wagering sub-system data feed 504 is generated by the mobile wagering sub-system 102. The mobile wagering sub-system data feed 504 includes information such as the tournament leader information, which can be converted into an easily readable display format.

For example, the mobile wagering sub-system data feed 504 may be transmitted over the Internet to a Real Time Messaging Protocol (RTMP) host 506, which may then transmit the data signal from the illustrative RTMP host 506 using an RTMP protocol over the Internet to the illustrative VPS client 116.

The broadcast preparation software module 502 may also be configured to interface with an illustrative audio mixer 508, which accepts a variety of audio feeds. The illustrative audio feeds received by the audio mixer 508 include host microphones and audio from selected live game play; a wide variety of such devices are commercially available. Additionally, the broadcast preparation software module 502 is configured to provide live field reporting 510 from game locations using a tool such as Facetime™. Live field reporting 510 may add excitement to the broadcast. Furthermore, the broadcast preparation software module 502 is configured to interface with various video signals that include studio video cameras 512 and live images captured from illustrative authorized mobile device and replayed as feed 514 and feed 516.

Referring to FIG. 6, there is shown a more detailed view of an illustrative video presentation sub-system (VPS) client 116. In the illustrative embodiment, the VPS client 116 is communicatively coupled to the video presentation sub-system 104 via an illustrative wide area network, e.g. Internet, and a local wireless connection, e.g. local Wi-Fi. The illustrative RTMP feed 602, which is generated by the RTMP host 506, is received by the VPS client 116. The VPS client is also operationally coupled to the illustrative stationary monitor 110.

The RTMP feed 602 is received at an illustrative gaming venue and the RTMP feed 602 is routed to the VPS client 116. By way of example and not of limitation, the RTMP feed 602 is communicated using a dedicated and secure Wi-Fi channel. In the illustrative embodiment, the RTMP feed 602 includes a streaming video data stream, which is converted to a video display signal. For example, the RTMP feed may be converted to an HDMI video signal with an RTMP/HDMI converter 604. For example, the RTMP/HDMI converter 604 may be implemented with special purpose firmware inside an embedded computing element, such as a Raspberry PI™. The resulting video signal generated by the RTMP/HDMI converter 604 is then sent directly to a compatible television or sent to the television using a commercial 2×1 switch 607, such as the Fosman 8024™, which may also be coupled to an existing HDTV data source such as receiver 606.

The illustrative converted HDMI video signal is then presented on the stationary monitor 110. This allows for a variety of installation models. Where there is a television dedicated to use with the VPS the output of the special purpose RTMP/HDMI converter 604 may be left permanently connected to the television or stationary monitor 110. If the television is used for different purposes at different times the data feed to the television can be switched on or off with the introduction of the 2×1 HDMI switch 607, allowing normal use of the television when the VPS data feed is not in use.

The centralized gaming system 100 described in FIG. 1 through FIG. 6 supports a variety of different types of games and game play, including placeholder feature electronic pull-tab game play. For the illustrative mobile wagering sub-system 102, a game session is initiated after a wager is received and the game session ends when game play is completed, when a prize is awarded, or according to any other predetermined game mechanic that reflects the game session has ended.

A variety of different game mechanics may be associated with each game session. For example, a tournament game awarding a limited number or prizes may present player rankings for prizes awarded to the ranked players. For another example, an electronic pull-tab tournament game may award limited or no prizes to players based on player rankings, since the electronic pull-tab tickets themselves may award the tournament players prizes.

The player rankings may then be presented on one or more of the authorized mobile devices 112. Additionally, the player rankings may result in the video presentation sub-system 104 generating a player rankings game session output that is presented on the stationary monitors 110.

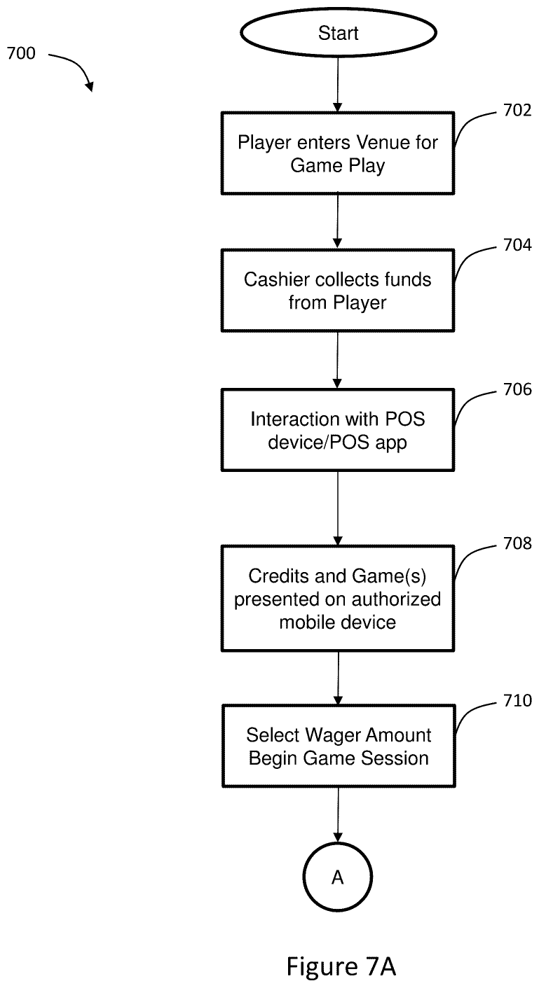

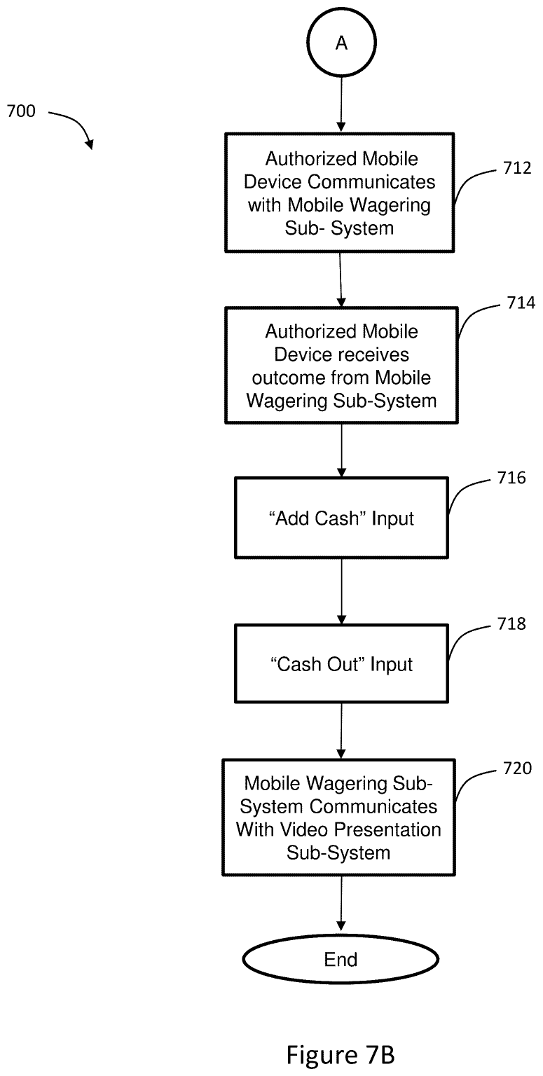

Referring to FIGS. 7A and 7B, there is shown an illustrative centralized gaming method that describes the various steps performed by a player interacting with the gaming system. The illustrative centralized gaming method 700 is at block 702 where an illustrative player enters one of the venues and indicates to the cashier or similar venue employee that the player wants to initiate game play with the centralized gaming system 100. The method then proceeds to block 704 where the illustrative cashier collects monetary funds such as cash, e-money, debit card, credit card and other such monetary funds as are appropriate depending on jurisdictional regulatory requirements.

At block 706, the illustrative cashier then proceeds to interface with a Point-Of-Sale (POS) application on a device such as POS device 114. In another embodiment, the player may interface with a kiosk version of the POS device 114 without the need to interact with a venue employee. In yet another embodiment, the POS application may be running on an authorized mobile device 112 and the player may interact directly with the POS application.

While interfacing with the POS device or POS application at block 706, the illustrative cashier identifies the authorized mobile device 112 associated with the player. The illustrative cashier then proceeds to enter the amount of credits to add to the authorized mobile devices. This amount of credits is stored in illustrative central database 314 (shown in FIG. 3).

At block 708, the total credits, which correspond to the collected funds, are presented on the authorized mobile device 112. The player may then interact with a game application running on the authorized mobile device. The player may also select from a variety of different game applications, which may be presented as a menu of games displayed on the authorized mobile device 112 screen. In operation, various game screens corresponding to the chosen game are presented to the player.

At block 710, the player can select a wager amount for a particular game session. In the illustrative embodiment, the wager amount includes the number of credits the player has selected to be wagered. Depending on jurisdictional requirements wager amounts can be expressed in dollars and cents (or other local currency) or in terms of credits, where each unit of credit has a monetary value. By way of example and not of limitation, the player may then initiate the game session by pressing a PLAY button, which is an illustrative game input received by the authorized mobile device 112.

At block 712, a game request is sent from the authorized mobile device 112 to the mobile wagering sub-system 102. The mobile wagering sub-system 102 processes the game request. In the illustrative embodiment, the mobile wagering subsystem 102 determines a prize result and a graphic representation (or representations) of the prize result. Additionally, the mobile wagering sub-system 102 logs the transaction, updates database game information, and updates an accounting module to reflect the amount spent and player winnings corresponding to the game session. Furthermore, the mobile wagering sub-system 102 sends a response message (or messages) to the authorized mobile device specifying the information to be displayed and the new value of the player account.

The method then proceeds to block 714 where the authorized mobile device 112 receives the outcome(s) from the mobile wagering sub-system 102. For example, the authorized mobile device 112 is configured to present animations and other results associated with the game session. The authorized mobile device 112 may also include an updated accounting of total credits and the prize amounts awarded. After the game session is completed, the player can return to the game menu at any time and select a different game to play.

At block 716, the authorized mobile device receives an “Add Cash” input. By way of example, the player decides to add funds to their play amount by providing the “Add Cash” input, which alerts the illustrative cashier that the player wants to add cash to their session total. The cashier then proceeds to interact with the POS device 114 or POS App (not shown). The illustrative cashier then proceeds to enter the amount of credits to add to the authorized mobile devices and the credits are stored in the illustrative central database 314.

At block 718, the authorized mobile device receives a “Cash Out” input. For example, when the player has finished the game session and wants to “Cash Out” the player presses a “Cash Out” button on the authorized mobile device 112. In the illustrative embodiment, after the authorized mobile device receives the “Cash Out” input, the illustrative cashier is notified that the player desires to “Cash Out.” Using the POS device 114 of the POS App (not shown), the illustrative cashier selects the “Cash Out” input and obtains the total credits remaining on the authorized mobile device after has completed one or more game session. The remaining account total information is received from the mobile wagering sub-system 102. The cashier pays the player the amount due and confirms the payment at the POS. The client device is then available for use by another player.

The method then proceeds to block 720 where mobile wagering sub-system 102 is configured to communicate with the video presentation sub-system 104. At block 720, the video presentation subsystem 104 receives game play information and integrates it with other data sources as described above. The video presentation subsystem 104 generates a video presentation that is broadcast via a private network to participating gaming venues. As described above a stationary monitor 110 is communicatively coupled to the video presentation sub-system 104 via the video presentation client 116. The stationary monitor client is configured to receive and present the game session output generated by the video presentation sub-system. In one illustrative embodiment, the video content is designed to provide enhanced content to the players and to increase the interaction between the players and the games. Additionally, the video content adds interest and excitement to the games. In addition to game-specific content, such as broadcasting a live tournament, the system can be used for a multitude of purposes, including, but not limited to, announcements and pictures on winners, informational videos about sponsoring charities, announcements of new games and upcoming events, advertising, etc.

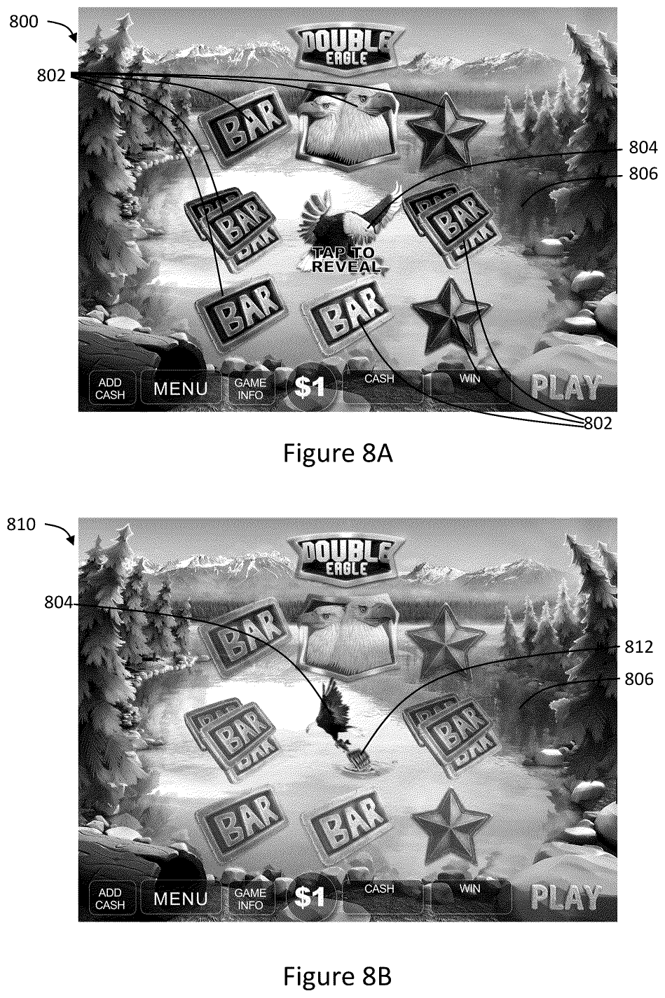

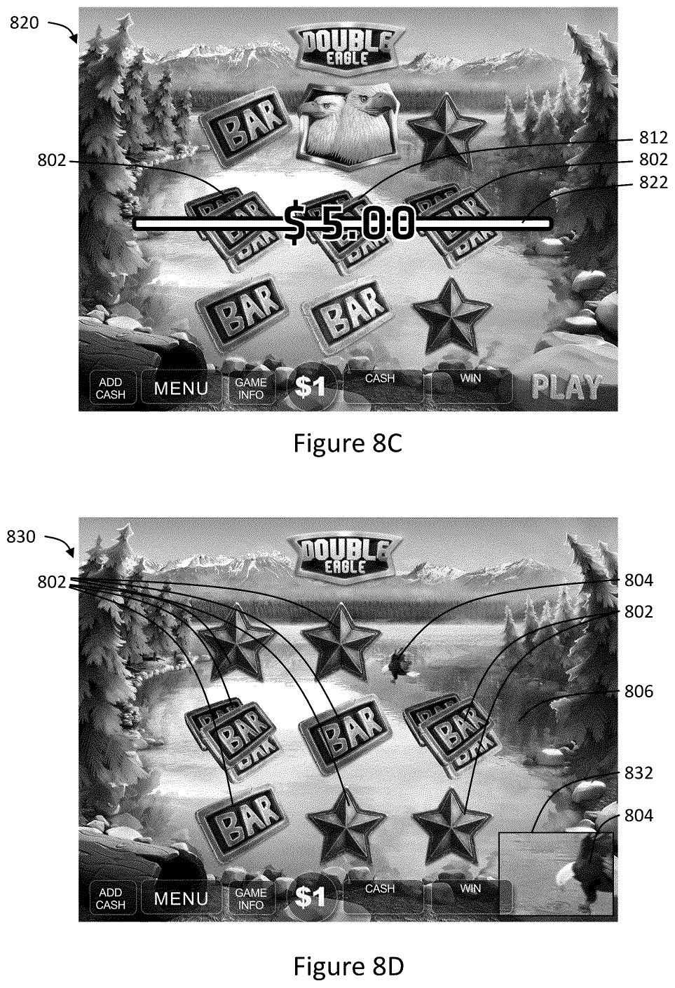

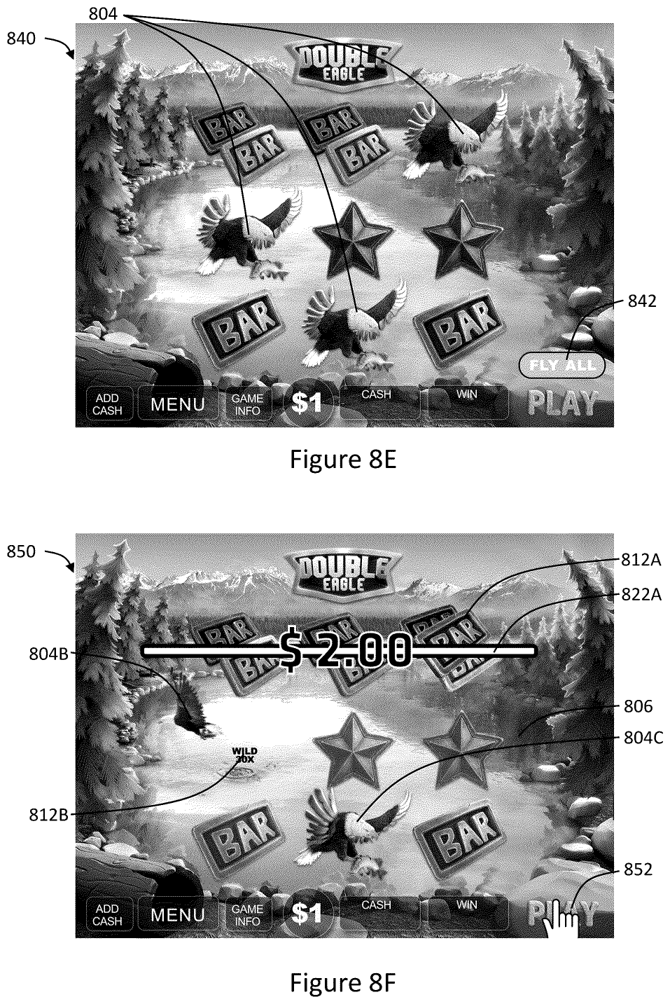

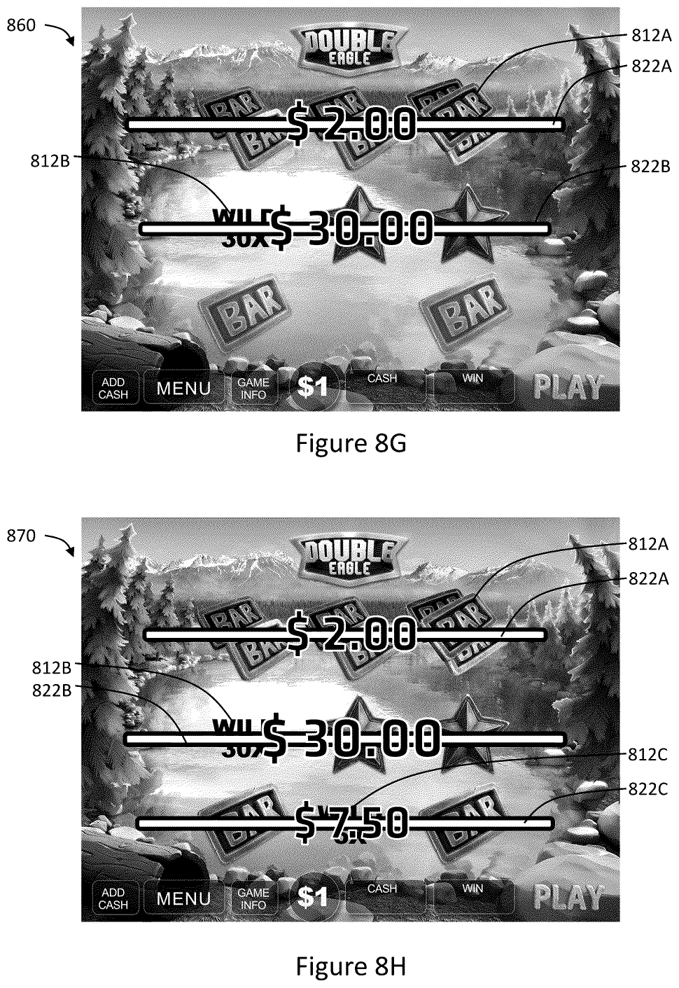

Referring now to FIGS. 8A-H, there are shown illustrative game screens 800, 810, 820, 830, 840, 850, 860, and 870 that depict various stages and animations of single symbol placeholder electronic pull-tab gameplay. In FIG. 8A, the illustrative game screen 800 shows a revealed set of 9 initial game symbols in a 3×3 grid presented in a foreground display area. The 9 initial game symbols include 8 standard game symbols 802 surrounding a single placeholder symbol 804. The 9 initial game symbols 802 and 804 are displayed in the foreground grid in front of a background display area 806. The illustrative background display area 806 is a mountain scene surrounding a lake comprising all of the visible portions of the electronic pull-tab ticket except for the game buttons, game meters, and the initial and final game symbols 802 and 804

While the illustrative embodiment presents a grid of game symbol display positions, the term “grid” is interchangeable with similar terms, such as “reel”, unless otherwise stated herein. Further, a grid may comprise a single row, a single column, multiple rows, and/or multiple columns, and is not limited to the illustrative 3×3 grid depicted in FIG. 8A and other figures herein. Further still, each row or column of a grid is not limited to three (3) game symbol display positions, and may include more or fewer game symbol display positions.

The placeholder symbol 804 is not part of the paytable for the illustrative placeholder electronic pull-tab ticket, as it is not a final game symbol and instead merely covers or holds the place of a final game symbol that has not yet been revealed.

In FIG. 8B, the illustrative game screen 810 shows the placeholder symbol 804 during a placeholder reveal animation triggered by a player input, such as clicking, pressing, or selecting the placeholder symbol 804. The placeholder reveal animation may be termed generally an entertaining animation enhancement. During the placeholder reveal animation, the placeholder symbol 804 animates from its position in the game grid, and retrieves a final game symbol 812 for placement in the game grid position previously occupied by the placeholder symbol 804. In the illustrative embodiment, the placeholder symbol 804 is an eagle that flies into the background display area 806 to retrieve the final game symbol 812, which is triple bar symbol.

In the illustrative embodiment, the entertaining animations disclosed herein are elements of the primary game session. In some embodiments, the entertaining animations disclosed herein are elements of (or comprise entirely) a bonus game session.

In FIG. 8C, the illustrative game screen 820 shows the resulting grid of final game symbols resulting in a winning payline 822 formed by two initial game symbols (now final game symbols) 802 and the newly revealed final game symbol 812. In the illustrative game screen 820, the eagle placeholder symbol has completed its animation and deposited the triple bar final game symbol 812 in the center position of the game grid that was previously occupied by the eagle placeholder symbol 804.

In FIG. 8D, the illustrative game screen 830 shows a second placeholder reveal animation that includes a picture-in-picture 832 view of the eagle placeholder symbol 804 retrieving a final game symbol from the background display area 806. While the illustrative embodiment places the picture-in-picture view 832 in a corner of the display area that does not impede the view of the grid of game symbols 802, the picture-in-picture view 832 may occupy any portion of the display area, including any portion of the grid of game symbols 802. Further, while the illustrative picture-in-picture view 832 is opaque and blocks the view of the display area behind the view 832, the picture-in-picture view 832 may be translucent and show an occluded view of the display area or any game symbols 802, 804, and 812 behind the view 832.

In FIG. 8E, the illustrative game screen 840 shows a particular placeholder electronic pull-tab ticket displaying three placeholder symbols 804. The illustrative game screen 840 also includes a “FLY ALL” button, that when pressed causes the placeholder reveal animation to occur for all placeholder symbols 804 present in the game grid. Thus, the gaming device displaying the illustrative placeholder electronic pull-tab ticket may receive player input that causes the gaming device to reveal all final game symbols covered by one or more placeholder symbols 804. In some embodiments, multiple placeholder symbols 804 may cover final game symbols in the game grid, up to and including every final game symbol in the game grid. For example, the illustrative 3×3 game grid may comprise nine (9) placeholder symbols 804 covering nine (9) final game symbols.

In FIG. 8F, the illustrative game screen 850 shows game screen 840 after a player has tapped a first placeholder symbol (not shown) to reveal a triple bar final game symbol 812A and tapped a second placeholder symbol 804B to reveal a WILD 30X final game symbol 812B. When the first placeholder reveal animation completes, a winning payline 822A passing through the revealed final game symbol 812A is displayed on the game grid.

In the illustrative embodiment, instead of tapping a particular placeholder symbol 804 to reveal a final game symbol, the player input was received by the gaming device in the form of a press or click on the PLAY button 852. In some embodiments, pressing the PLAY button 852 may cause only one placeholder symbol 804 to perform a placeholder reveal animation of a final game symbol, thus requiring multiple player input to reveal all final game symbols. In some embodiments, pressing the PLAY button 852 may cause every placeholder symbol 804 to perform a placeholder reveal animation of a final game symbol. Where only a single player input is required for multiple placeholder reveals, the placeholder reveals may occur sequentially (one-at-a-time), in concert (a single animation where every placeholder symbol performs an independent animation at the same time), or be skipped entirely so that the player is not required to wait for any reveal to complete (the placeholder symbols simply change in the game grid positions to become final game symbols in those same positions).

In FIG. 8G, the illustrative game screen 860 shows game screen 840 after a player has tapped the first placeholder symbol (not shown), the second placeholder symbol (not shown), and the third placeholder symbol (not shown) to reveal the first final game symbol 812A and the second final game symbol 812B, but before the third final game symbol (not shown) has been revealed through its own placeholder reveal animation. At this stage of the game session, the first payline 822A passing through the first final game symbol 812A and a second payline 822B passing through the second final game symbol 812B are shown on the game grid.

In FIG. 8H, the illustrative game screen 870 shows game screen 840 after the player has tapped all of the placeholder symbols and the associated placeholder reveal animations have occurred to reveal the first final game symbol 812A, the second final game symbol 812B, and the third final game symbol 812C. At this stage, since all final game symbols are now revealed, every payline 822 is displayed on the game screen. In the illustrative embodiment, each final game symbol 812 revealed by their associated placeholder symbol resulted in a single winning payline 822 displayed on the game screen 870. In some embodiments, the reveal of single final game symbol may result in multiple winning paylines, each of which would be displayed on the game screen for the player.

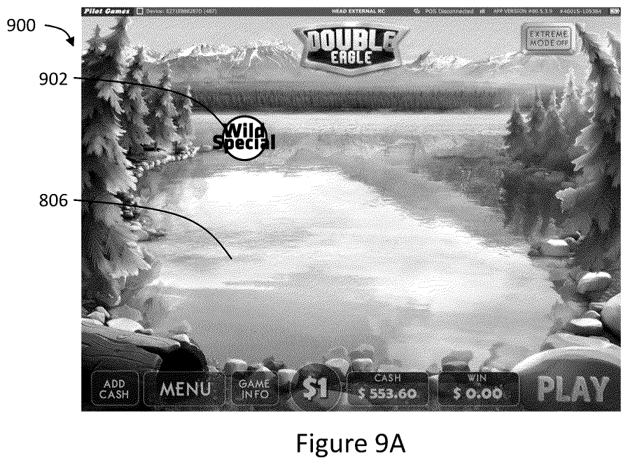

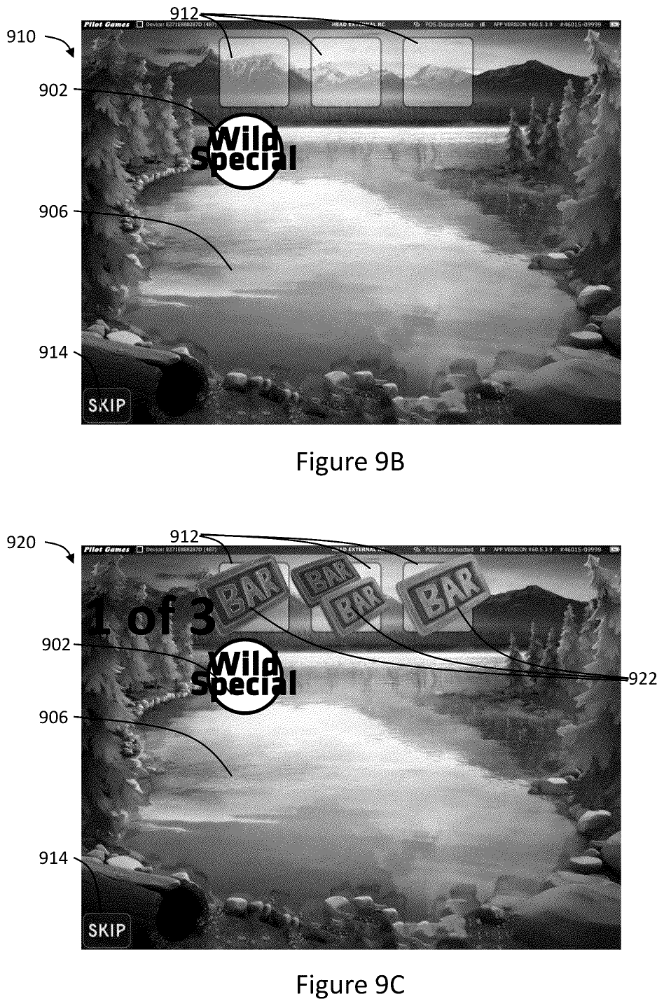

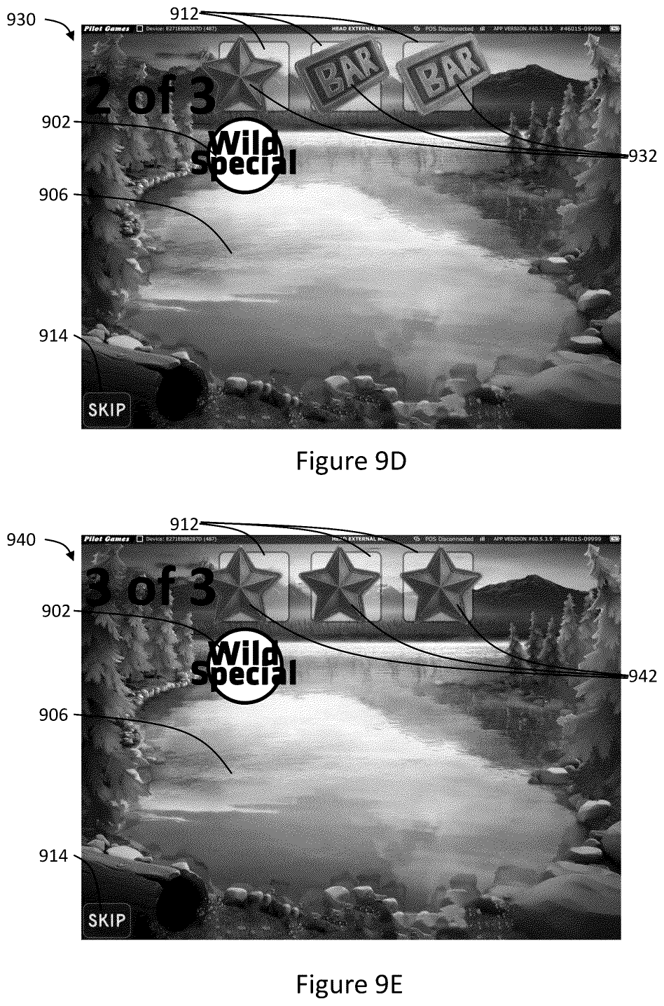

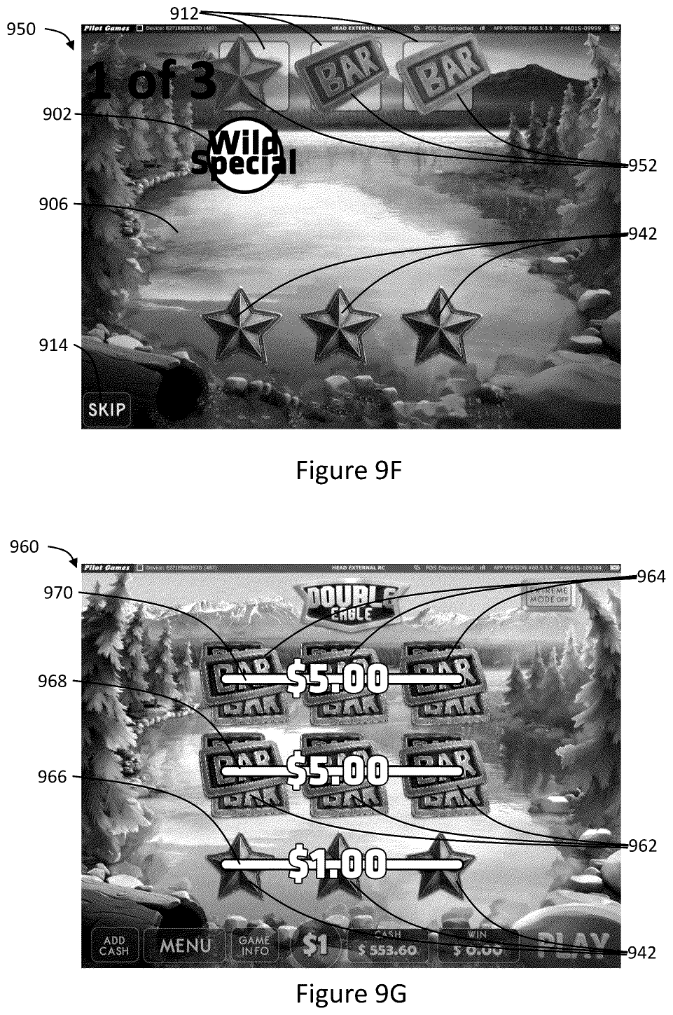

With reference now to FIGS. 9A-G, there are shown illustrative game screens 900, 910, 920, 930, 940, 950, and 960 that depict various stages and animations of grid symbol placeholder electronic pull-tab gameplay with a Replay animation. In FIG. 9A, the illustrative game screen 900 shows placeholder electronic pull-tab ticket gameplay immediately after player input has initiated a ticket reveal that revealed a Wild Special placeholder symbol 902. In the illustrative embodiment, the Wild Special placeholder symbol 902 operates as a placeholder covering every symbol of a game grid. As such, when the Wild Special grid placeholder symbol 902 is revealed no other game symbols are revealed in the game grid of the foreground display area and only the placeholder symbol 902 and the background display area 806 are visible to the player on their gaming device.

In FIG. 9B, the illustrative game screen 910 shows the next stage of gameplay after reveal of the Wild Special grid placeholder symbol 902. After presentation of the Wild Special grid placeholder symbol 902, Replay symbol display positions 912 and a SKIP button 914 appear on the game screen 910. In the illustrative embodiment, the Replay symbol display positions 912 comprise a single row of display positions shown above the game grid area. The SKIP button 914 may receive a player input, such as a press on a touchscreen, a click on a computer screen, etc., and cause the animation triggered by the display of the Wild Special grid placeholder symbol 902 to terminate, such that all final game symbols and paylines are revealed to the player immediately.

In some embodiments, the Replay symbol display positions 912 comprise an entire grid having multiple rows and columns of Replay symbol display positions 912. In some embodiments, the Replay symbol display positions 912 are positioned over and in front of the game grid location, such that the Replay symbol display positions 912 overlay the game grid. In these overlaying embodiments, the Replay symbol display positions 912 and any symbols later displayed therein may be translucent, opaque, or any combination thereof.

In the illustrative embodiment, the background 806 of FIG. 9A transitions to the background 906. However, in other embodiments, no background transition occurs. In still other embodiments, the background transition from 806 to 906 corresponds to a gameplay mode selected by the player, such as standard mode (associated with background 806 of FIG. 9A) and extreme mode (associated with background 906), where extreme causes electronic pull-tab tickets on a gaming device to have a higher volatility than in the standard mode.

In FIG. 9C, the illustrative game screen 920 shows a first set of Replay symbols 922 in the Replay symbol display positions 912 that are candidates for the final game symbol display positions in the bottom row of a 3×3 grid of final game symbols. However, the first set of Replay symbols 922 do not represent a winning combination of symbols. Since the displayed first set of Replay symbols 922 do not form a winning combination, the first set of Replay symbols 922 are discarded and a second set of Replay symbols are displayed.

In FIG. 9D, the illustrative game screen 930 shows a second set of Replay symbols 932 in the Replay symbol display positions 912 that do not represent a winning combination of symbols. Since the displayed second set of Replay symbols 932 do not form a winning combination, the second set of Replay symbols 932 are discarded and a third set of Replay symbols are displayed.

In FIG. 9E, the illustrative game screen 940 shows a third set of Replay symbols 942 in the Replay symbol display positions 912 that do represent a winning combination of symbols. Since the Replay symbols 942 represent a winning combination of game symbols, this third set of Replay symbols 942 will be retained as one paying line of a 3×3 grid of game symbols presented in the foreground display area. However, the third set of Replay symbols 942 would still be retained even if they did not represent a winning combination of game symbols because this was the last set of Replay symbols to be displayed to the player. Additionally, since the Wild Special grid placeholder symbol 902 covers an entire 3×3 grid of final game symbols and only three final game symbols (the three Replay symbols of the third set 942) have been revealed, the Wild Special grid placeholder symbol 902 continues to be displayed on the game screen 940.

In FIG. 9F, the illustrative game screen 950 shows a first set of Replay symbols 952 in the Replay symbol display positions 912 that are candidates for the final game symbol display positions in the middle row of a 3×3 grid of final game symbols. In game screen 950, the previously displayed set of Replay symbols 942 have now been displayed as the bottom row of game symbols in the 3×3 symbol grid. Since the first set of Replay symbols 952 do not represent a winning combination of symbols they are discarded and a second set of Replay symbols are displayed. This process of displaying sets of Replay symbols will continue until each row of the game grid is full of revealed final game symbols.

In FIG. 9G, the illustrative game screen 960 shows the final game symbols 942, 962, and 964 displayed for the game grid and the winning paylines 966, 968, and 970 associated with the final game symbols. In the illustrative embodiment, three sets of Replay symbols were sequentially displayed to the player through FIGS. 9C-F, until each set of Replay symbols displayed a winning payline 966, 968, and 970. In some embodiments, no set of Replay symbols displayed to the player for a particular row of the game grid results in a winning payline, while at least one set of Replay symbols displayed to the player for a different row of the game grid does result in a winning payline. In further embodiments, The Replay symbols ultimately selected as final game symbols for different rows of the game grid result in vertical and/or diagonal paylines that span multiple rows of the game grid.

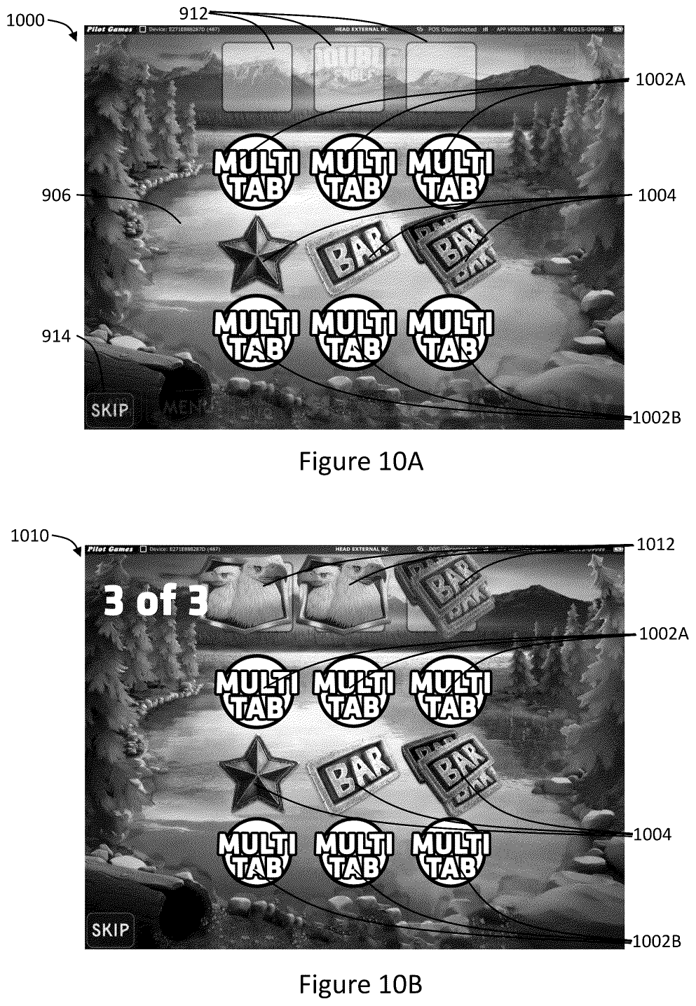

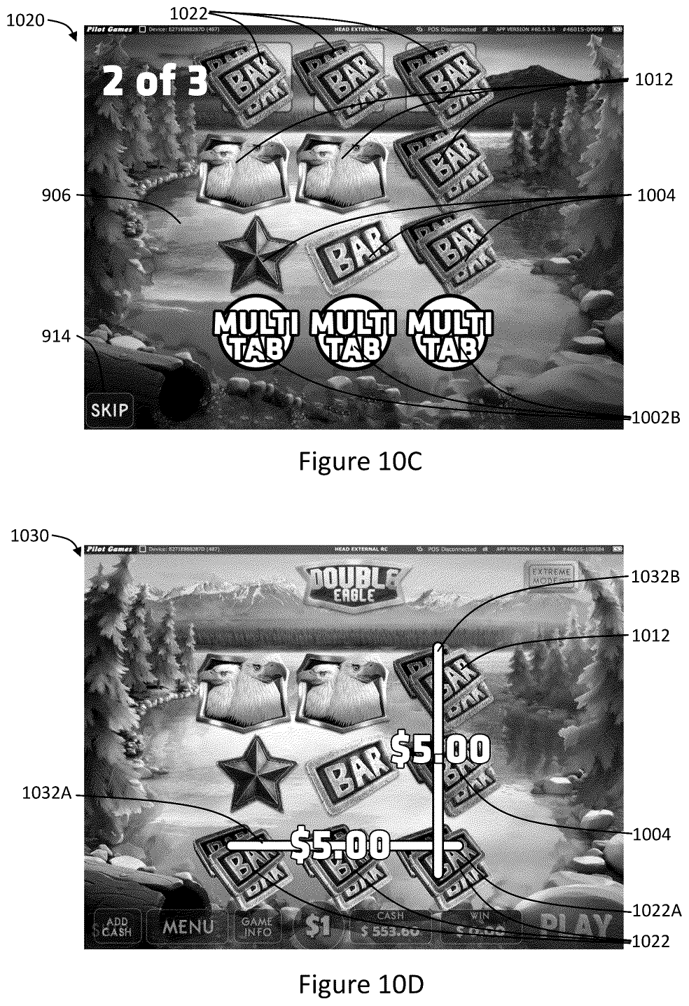

With reference now to FIGS. 10A-E, there are shown illustrative game screens 1000, 1010, 1020, and 1030 that depict various stages and animations of row symbol placeholder electronic pull-tab gameplay with a Replay animation. In FIG. 10A, game screen 1000 shows gameplay after receiving a first player input to initiate a game session and reveal the initial game grid symbols. In this embodiment, the revealed initial game symbols include row placeholder symbols 1002A and 1002B covering the final game symbols of the top and bottom rows of the game grid, as well as initial game symbols in the middle row of the game grid that appear in the paytable for this game, and thus are final game symbols 1004. As with the embodiments discussed above for FIGS. 9B-F, the game screen 1000 includes Replay symbol display positions 912 where sets of Replay game symbols will be revealed to the player through an entertaining animation enhancement.

In FIG. 10B, game screen 1010 shows gameplay after the gaming device received a second player input that initiated the Replay entertaining animation enhancement. In some embodiments, the player input is a mouse click, a touchscreen tap, or a button press that starts the Replay entertaining animation enhancement for the top row of Replay placeholder symbols 1002A. The Replay entertaining animation enhancement cycled through two sets of Replay symbols that did not represent a winning payline before presenting a third set of Replay symbols 1012 that also do not represent a winning payline, but become final game symbols for inclusion in the game grid since this third set of Replay symbols 1012 is the last set to be presented to the player.

In FIG. 10C, game screen 1020 shows gameplay after completing the first Replay entertaining animation enhancement for the top row of the game grid resulting in the reveal of the final game symbols 1012, and after receiving a third player input that initiated a second Replay entertaining animation enhancement. The second Replay entertaining animation enhancement included displaying a first set of Replay symbols that did not result in a winning payline, then displaying a second set of Replay symbols 1022 that do result in a winning payline, and thus will become the final game symbols for the bottom row of the game grid and replace the row placeholder symbols 1002B currently displayed.

In FIG. 10D, game screen 1030 shows gameplay after replacing the row placeholder symbols with the second set of Replay symbols 1022, resulting in two winning paylines 1032A and 1032B. The second set of Replay symbols 1022 became the final game symbols 1022 for the bottom row of the game grid because they represent a winning payline independent of the other rows of the game grid. However, the rightmost final game symbol in each row of the game grid 1012, 1004, and 1022A for a winning vertical payline 1032B as well.

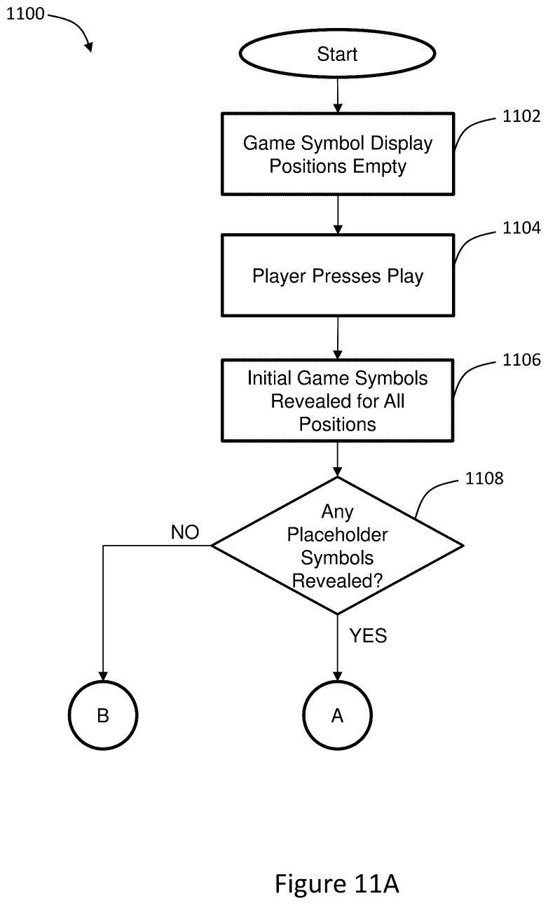

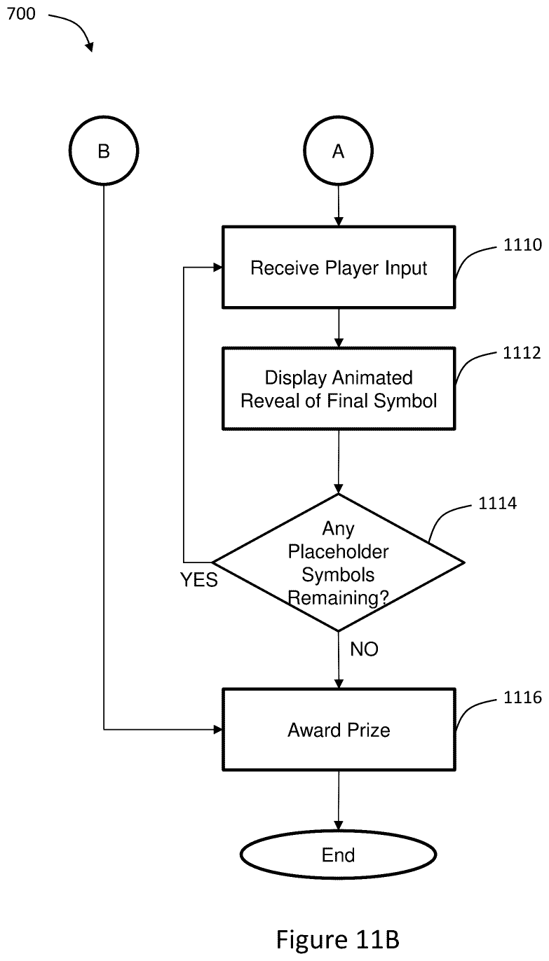

With reference now to FIGS. 11A and 11B, there is shown an illustrative flowchart for a method 1100 of providing single symbol placeholder electronic pull-tab tickets. The method 1100 begins at step 1102 where the gaming device displays empty game symbol display positions to the player.

At step 1104, the player initiates the game session with player input, such as a click, button press, or touch screen selection. In illustrative embodiment, the player selects a “PLAY” button to enter their player input and initiate the game session.

At step 1106, the gaming device presents or reveals a set of initial game symbols for all positions on the game grid. When the gaming device receives a placeholder electronic pull-tab ticket from the centralized gaming system, the placeholder electronic pull-tab ticket includes a variety of identifying data, such as a session identification number, an outcome, a symbol identification and location for each of the final symbols, and the location of any symbol cover objects. The outcome denotes the award value, if any, associated with the placeholder electronic pull-tab ticket. The symbol identification and location for each of the final symbols indicates the particular final game symbol, i.e., bar, double bar, triple bar, star, eagle, etc., and its location in a single line (i.e., row or column) or multi-row grid. When a placeholder electronic pull-tab ticket includes one or more placeholder symbols covering or obscuring final game symbols from the view of the player, the ticket includes meta data comprising an associated cover object and the location on the grid that the placeholder symbol will occupy. This meta data allows the game device to display a set of initial game symbols that may comprise all of the final game symbols (i.e., when no cover object is included in the meta data of the ticket indicating that no placeholder symbol is to be displayed), some of the final game symbols and one or more placeholder symbols obscuring one or more final game symbols (i.e., when one or more cover object is included in the meta data of the ticket), or no final game symbols because all final game symbols are obscured by placeholder symbols.

At decision diamond 1108, the gaming device determines whether any placeholder symbols have been revealed. When no placeholder symbols have been revealed, all initial game symbols are final game symbols and the method 1100 proceeds to step 1116 where any award associated with the game session is awarded. When one or more placeholder symbol has been revealed, the method proceeds to step 1110.

At step 1110, the game device receives player input indicating that the player wishes to reveal the final game symbol for the placeholder symbol's location on the game grid.

At step 1112, the game device presents an entertain animation enhancement that reveals the final symbol for the game grid location associated with the placeholder symbol.

At decision diamond 1114, the game device determines whether any placeholder symbols remain on the game grid. When the game device identifies one or more placeholder symbols remaining on the game grid, the method returns to step 1110 to await further player input indicating a desire to reveal the final game symbol for the location occupied by the placeholder symbol. When the game device does not identify any remaining placeholder symbols on the game grid, the method 1100 proceeds to step 1116 where any associated award is awarded because all final game symbols have been revealed.

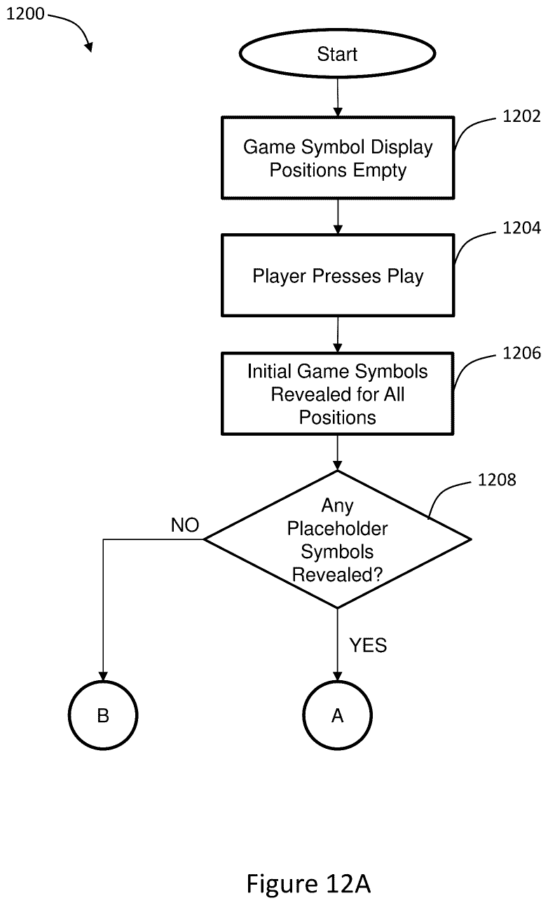

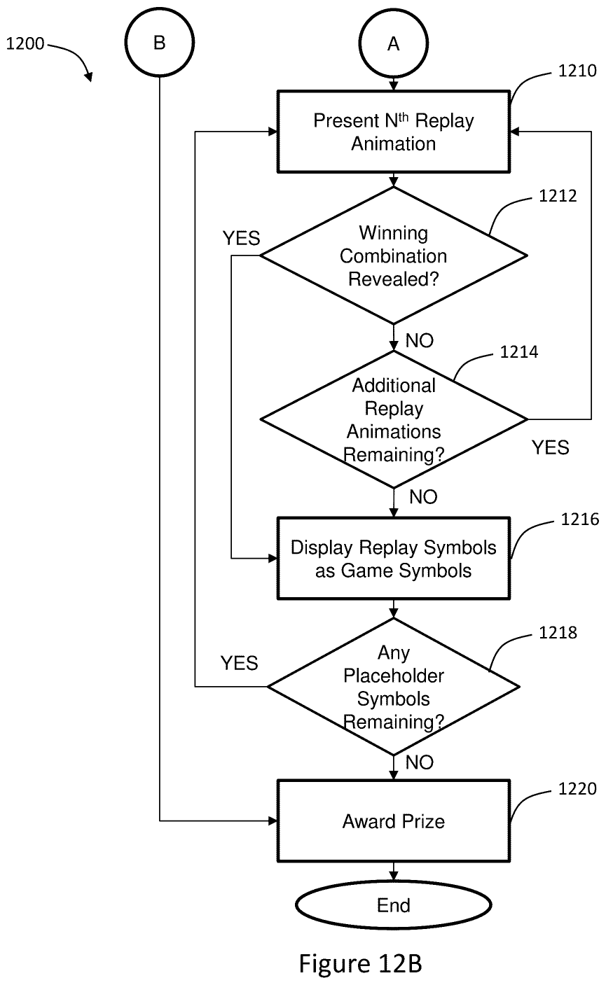

Referring now to FIGS. 12A and 12B, there is shown an illustrative flowchart for a method 1200 of providing row and grid placeholder electronic pull-tab tickets with a Replay animation. The method 1200 begins at step 1202 where the gaming device displays empty game symbol display positions to the player.

At step 1204, the player initiates the game session with player input, such as a click, button press, or touch screen selection. In illustrative embodiment, the player selects a “PLAY” button to enter their player input and initiate the game session.

At step 1206, the gaming device presents or reveals a set of initial game symbols for all positions on the game grid. When the gaming device receives a placeholder electronic pull-tab ticket from the centralized gaming system, the placeholder electronic pull-tab ticket includes a variety of identifying data, such as a session identification number, an outcome, a symbol identification and location for each of the final symbols, and any symbol cover objects and their respective locations. The outcome denotes the award value, if any, associated with the placeholder electronic pull-tab ticket. The symbol identification and location for each of the final symbols indicates the particular final game symbol, i.e., bar, double bar, triple bar, star, eagle, etc., and its location in a single line (i.e., row or column) or multi-row grid. When a placeholder electronic pull-tab ticket includes one or more placeholder symbols covering or obscuring final game symbols from the view of the player, the ticket includes meta data comprising an associated cover object and the location on the grid that the placeholder symbol will occupy. This meta data allows the game device to display a set of initial game symbols that may comprise all of the final game symbols (i.e., when no cover object is included in the meta data of the ticket indicating that no placeholder symbol is to be displayed), some of the final game symbols and one or more placeholder symbols obscuring one or more final game symbols (i.e., when one or more cover object is included in the meta data of the ticket), or no final game symbols because all final game symbols are obscured by placeholder symbols.

At decision diamond 1208, the gaming device determines whether any placeholder symbols have been revealed. When no grid or row placeholder symbols have been revealed, all initial game symbols are final game symbols and the method 1200 proceeds to step 1220 where any award associated with the game session is awarded. When one or more placeholder symbol has been revealed, the method proceeds to step 1210.

At step 1210, a Replay animation begins that displays a row of potential final game symbols to the player, termed Replay symbol sets. In the illustrative embodiment, up to three Replay symbol sets may be displayed to the player in succession. However, in some embodiments, more than three Replay symbol sets may be displayed to the player in succession. In other embodiments, fewer than three Replay symbol sets may be displayed to the player in succession. In some embodiments, the Replay animation is triggered by a player input, i.e., the Replay animation does not begin until the player selects the grid or row placeholder symbol.

At decision diamond 1212, the gaming device determines whether to accept the set of Replay symbols as final game symbols or to present a next Replay symbol set. The determination of whether to accept the set of Replay symbols as final game symbols is based on whether the set of Replay symbols present an independent winning combinations of final game symbols, i.e., whether a horizontal payline would pass through the set of Replay symbols if they were accepted as final game symbols. When the gaming device identifies the set of Replay symbols as a winning combination of symbols, the method 1200 proceeds to decision diamond 1218 whether the gaming device determines whether any placeholder symbols remain covering final game symbols. When the gaming device does not identify the first set of Replay symbols as a winning combination of symbols, the method 1200 proceeds to decision diamond 1214.

At decision diamond 1214, the gaming device determines whether any sets of Replay symbols remain. When the gaming device determines that one or more sets of Replay symbols remain, the method 1200 proceeds back to step 1210 where a second or N^{th} set of Replay symbols are presented as an animation to the player. When the gaming device determines that no sets of Replay symbols remain, the method 1200 proceeds to step 1216.

At step 1216, the winning or last remaining set of Replay symbols presented to the player are accepted as final game symbols and displayed in the game grid. When the foreground display area for final game symbols comprises only a single row of symbols, no specific row for display of the winning or last remaining Replay symbols is required. When the foreground display area for final game symbols comprises a grid of two or more rows of game display positions, the winning or last remaining set of Replay symbols are accepted into the row associated with the placeholder symbol associated with the Replay animation. When the placeholder symbol covers the entire game grid, the Replay symbols may fill rows in the game grid in order of presentation from the top or from the bottom, or randomly. In some embodiments, there will be an onscreen indication identifying for which row the presented Replay symbols sets are to substitute.

After accepting a set of Replay symbols as final game symbols and displaying those Replay symbols as final game symbols in the game grid, the method 1200 proceeds to decision diamond 1218. At decision diamond 1218, the gaming device determines whether any placeholder symbols remain. When the gaming device determines that at least one placeholder symbol remains, such as a grid placeholder symbol for which some rows of final game symbols have not yet been revealed, or for a remaining row placeholder symbol, the method 1200 returns to step 1210 where a new Replay animation begins for a new row in the game grid. When the gaming device determines that no placeholder symbol remains, the method 1200 proceeds to step 1220 where the prize associated with the electronic pull-tab ticket is awarded.

In some embodiments, the gaming device does not make any determinations for decision diamonds and steps 1212 through 1218, and instead merely displays an animation that makes it appear as though the gaming device is cycling through sets of Replay symbols until a winning set of Replay symbols appears, or until no more Replay symbol sets are available. In this animation-only embodiment, the animation played is triggered by further meta data on the electronic pull-tab ticket that associates the animation with a cover object.

The pull-tab games presented herein include an auto-close option that may be selected by the operator, for any game played at a particular venue. The auto-close option automatically replaces a finite game pool with a new pool when all prizes exceeding a predetermined value for the deck have been exhausted and the game may no longer be desirable by players. When the auto-close option is turned “ON,” a deck may automatically close and be replaced by a new deck when prizes over a game specific value set in the portal are gone. For example, a game may have 3 large value prizes and when the last prize is awarded, the deck may close and a new deck may open. By way of example and not of limitation, the auto close option is identified in the client game information when it is active, so players may know that it is active. A notification may also be given to all active clients when a new deck is open. This feature is attractive to players because they are always assured that there are always some valuable prizes remaining in a deck they may be playing.

The GLW 120 and MWS 102 systems are communicatively coupled to the VPS 104, which is communicatively coupled to the VPS video display as shown in FIG. 1. The VPS display provides the opportunity to highlight GLW players and the GLW events. The VPS display may be used to highlight regional standings, announce regional winners, show live or video clips of regional events, show live or video clips of the Tournament of Champions, show Interviews with PGL players, and other such GLW information. This close interaction between the VPS 104, MWS 102 and GLW 120 creates a social atmosphere, a spirit of competition, a sense of accomplishment, and improve the success of the wagering enterprise.

The illustrative gaming systems and methods presented above may include a plurality of server applications that configured to provide high-availability and redundancy, processes all inputs, generates outputs, and maintains a central database for accounting, game play, system configuration data, and other such data types. By way of example and not of limitation, critical system data regarding clients may be maintained a repository associated with the illustrative gaming system. Historical games results and leader board information may be maintained. Printable versions of this information may be available on the portal.

The illustrative client devices described in the illustrative embodiments are communicatively coupled to a gaming system database, which stores client device data. Additionally, the illustrative gaming system database is configured to be secure. Furthermore, the illustrative gaming system database manages the data that is received from client devices in geographically dispersed gaming venues.

The illustrative centralized gaming system may be disposed in a central site as described herein. The illustrative centralized gaming system may process information received over the internet backbone from client devices such as mobile devices, management terminals and other such client devices.

The illustrative MWS sub-system manages the funding of game play and operation of wagering games and overall system management. All gaming messaging between servers and client devices is sent and received over a secure internet network that directs network traffic to the appropriate server elements. A Portal service receives messages from management terminals and provides functionality to authorized users to control the system and access real-time and historical data. All server applications are structured to be deployable in a virtual server environment, configured for high availability with fail-over capabilities on hardware components and database structures that keep a multiplicity of all data records.

By way of example and not of limitation, the games supported by the wagering system include electronic pull-tabs, electronic pull-tab tournaments, placeholder feature electronic pull-tabs, linked bingo, high-speed linked bingo with entertainment, bingo tournaments, slot games, video poker, multi-player poker, blackjack, roulette, and other casino or entertainment games.

Many game types, including electronic pull-tabs and the entertainment aspect of linked bingo have bonus modes that award prizes based on a theme-specific animation. Often these features take more play time than a conventional game. While these features are entertaining, many players who have played the games for some period of time find the time spent in animation wasteful. Therefore, this system features a unique option at the beginning of any potentially long bonus animation. The player is presented with a screen announcing the bonus and then is presented with an option to proceed with the bonus animation or bypass the animation and go directly to the prize award at the end of the animation.

It is clear that the infrastructure of the MWS with the added capabilities of the VPS can support a wide variety of game types, in addition to the ones described herein. Those games include slot machine games, video lottery games, poker, blackjack, skill-based wagering games, among others.

It should be noted that in jurisdictions that allow gaming outside of physically licensed areas some of the above-mentioned security considerations may be relaxed or replaced by more appropriate mechanisms.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses may differ from those just described, or be expanded on or implemented using technologies not yet commercially viable, and yet still be within the inventive concepts of the present disclosure. The scope of the invention is determined by the following claims and their legal equivalents.

What is claimed is:

1. A pull-tab gaming system comprising:
a network component that generates an electronic pull-tab deck including a plurality of electronic pull-tab tickets, in which each of the plurality of electronic pull-tab tickets associated with a ticket value, a display area, and symbol identification and location for each of a plurality of final game symbols, wherein at least one electronic pull-tab ticket associated with a location for each of one or more placeholder symbols;
a plurality of game symbol display positions associated with the display area;
a gaming device communicatively coupled to the network component, wherein the gaming device includes a processor, a memory, and a display;
an electronic pull-tab ticket request generated by the gaming device that is communicated to the network component, which selects the at least one electronic pull-tab ticket associated with the location for one or more placeholder symbols;
the gaming device receives the electronic pull-tab ticket from the network component and displays the display area corresponding to the electronic pull-tab ticket; and
an input received at the gaming device causes the gaming device to present an animation corresponding to the ticket value, the display area, the symbol identification and location for each of the plurality of final game symbols, and the location for each of the one or more placeholder symbols;
wherein the animation displays the one or more placeholder symbols covering one or more final game symbols;
wherein the animation displays removing the one or more placeholder symbols to reveal the one or more final game symbols covered by the one or more placeholder symbols.

2. The pull-tab gaming system of claim 1 wherein each of the plurality of final game symbols corresponds to one or more entries in a paytable, and wherein each of the one or more placeholder symbols does not correspond to any entries in the paytable.

3. The pull-tab gaming system of claim 1 wherein the animation further includes display of at least one of the one or more placeholder symbols moving from a location to retrieve a corresponding final game symbol for display in the display area.

4. The pull-tab gaming system of claim 3 wherein the animation further includes a picture-in-picture element displaying the at least one of the one or more placeholder symbols moving from the location to retrieve the corresponding final game symbol for display in the display area.

5. The pull-tab gaming system of claim 4 wherein the picture-in-picture element is one of opaque and translucent.

6. The pull-tab gaming system of claim 1 wherein each of the one or more placeholder symbols covers one final game symbol.

7. The pull-tab gaming system of claim 1 wherein each of the one or more placeholder symbols covers a plurality of final game symbols.

8. The pull-tab gaming system of claim 1 wherein the at least one electronic pull-tab ticket having the location for one or more placeholder symbols further includes metadata indicating the animation includes a replay animation that presents a series of sets of one or more replay symbols, wherein one of a winning set of replay symbols and a last set of replay symbols in the series of sets of one or more replay symbols are substituted for final game symbols.

9. A pull-tab gaming method comprising:
generating an electronic pull-tab deck, by a network component, that includes a plurality of electronic pull-tab tickets, in which each of the plurality of electronic pull-tab tickets associated with an award value, a display area, and a symbol identification and location for each of a plurality of final game symbols, wherein at least one electronic pull-tab ticket associated with a location for each of one or more placeholder symbols;
providing a plurality of game symbol display positions associated with the display area;
communicatively coupling a gaming device to the network component, wherein the gaming device includes a processor, a memory, and a display;
generating, by the gaming device, an electronic pull-tab ticket request;
communicating, by the gaming device, the electronic pull-tab ticket request to the network component;
selecting, by the network component, the at least one electronic pull-tab ticket associated with the location for one or more placeholder symbols;
receiving, by the gaming device, the at least one electronic pull-tab ticket having the location for one or more placeholder symbols and displaying the display area corresponding to the electronic pull-tab ticket; and
receiving, by the gaming device, an input that causes the gaming device to present an animation corresponding to the award value, the display area, the symbol identification and location for each of the plurality of final game symbols, and the location for each of the one or more placeholder symbols;
wherein the animation displays the one or more placeholder symbols covering one or more final game symbols in the display area;
wherein the animation displays removing the one or more placeholder symbols to reveal the one or more final game symbols covered by the one or more placeholder symbols in the display area.

10. The pull-tab gaming method of claim 9 wherein each of the plurality of final game symbols corresponds to one or more entries in a paytable, and wherein each of the one or more placeholder symbols does not correspond to any entries in the paytable.

11. The pull-tab gaming method of claim 9 wherein the animation further includes displaying at least one of the one or more placeholder symbols moving from a location to retrieve a corresponding final game symbol for display in the display area.

12. The pull-tab gaming method of claim 11 wherein the animation further includes a picture-in-picture element displaying the at least one of the one or more placeholder symbols moving from the location to retrieve the corresponding final game symbol for display in the display area.

13. The pull-tab gaming method of claim 12 wherein the picture-in-picture element is one of opaque and translucent.

14. The pull-tab gaming method of claim 9 wherein each of the one or more placeholder symbols covers one final game symbol.

15. The pull-tab gaming method of claim 9 wherein each of the one or more placeholder symbols covers a plurality of final game symbols.

16. The pull-tab gaming method of claim 9 wherein the at least one electronic pull-tab ticket having the location for one or more placeholder symbols further includes metadata indicating the animation includes a replay animation that presents a series of sets of one or more replay symbols, wherein one of a winning set of replay symbols and a last set of replay symbols in the series of sets of one or more replay symbols are substituted for final game symbols.

17. A pull-tab gaming system comprising:
a network component that generates an electronic pull-tab deck including a plurality of electronic pull-tab tickets, in which each of the plurality of electronic pull-tab tickets associated with an award value, a foreground display area, a background display area, and a symbol identification and location for each of a plurality of final game symbols, wherein at least one electronic pull-tab ticket is associated with a location for each of one or more placeholder symbols;
a plurality of game symbol display positions associated with the foreground display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket from the electronic pull-tab deck;
the gaming device receives the electronic pull-tab ticket from the network component and displays both the background display area and the foreground display area corresponding to the electronic pull-tab ticket; and
the gaming device presents an animation when the selected electronic pull-tab ticket is associated with the location for one or more placeholder symbols, wherein the presented animation corresponds to the award value, the foreground display area, the background display area, the symbol identification and location for each of the plurality of final game symbols, and the location for each of the one or more placeholder symbols;
wherein the animation displays the one or more placeholder symbols covering one or more final game symbols in the foreground display area;
wherein the animation displays removing the one or more placeholder symbols to reveal the one or more final game symbols covered by the one or more placeholder symbols in the foreground display area.

18. The pull-tab gaming system of claim 17 wherein each of the plurality of final game symbols corresponds to one or more entries in a paytable, and wherein each of the one or more placeholder symbols does not correspond to any entries in the paytable.

19. The pull-tab gaming system of claim 17 wherein the animation further includes display of at least one of the one or more placeholder symbols moving from a location in the foreground display area to retrieve a corresponding final game symbol from the background display area for display of the corresponding final game symbol in the background display area.

20. The pull-tab gaming system of claim 19 wherein the animation further includes a picture-in-picture element displaying the at least one of the one or more placeholder symbols moving from the location in the foreground display area to retrieve the corresponding final game symbol from the background display area for display in the foreground display area.
